(19) United States
(12) Patent Application Publication
(10) Pub. No.: US 2016/0253758 A1
(43) Pub. Date: Sep. 1, 2016

(54) Insulated Account Datastructure Apparatuses, Methods and Systems

(71) Applicant: FMR LLC, Boston, MA (US)

(72) Inventor: Sean Riggle, Jersey City, NJ (US)

(21) Appl. No.: 14/632,889

(22) Filed: Feb. 26, 2015

(51) Int. Cl. G06Q 40/06

(52) U.S. Cl. CPC G06Q 40/06

(57) ABSTRACT

The Insulated Account Datastructure Apparatuses, Methods and Systems (“IAD”) transforms purchase request and investment request inputs via IAD components into order request, purchase response, and investment response outputs. An investment request associated with trading a security may be obtained from a beneficiary associated with an insulated account. Investment approval obtaining settings associated with the insulated account may be determined, and an investment approval notification may be sent for a custodian associated with the insulated account in accordance with the investment approval obtaining settings. An investment approval response indicating approval for trading the security may be obtained from the custodian. A securities order for the security may be generated from the custodian from the insulated account.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address asset information technology, and more particularly, include Insulated Account Datastructure Apparatuses, Methods and Systems.

### BACKGROUND

People own all types of assets, some of which are secured instruments to underlying assets. People have used exchanges to facilitate trading and selling of such assets. Computer information systems, such as NAICO-NET, Trade*Plus and E*Trade allowed owners to trade securities assets electronically.

### BRIEF DESCRIPTION OF THE DRAWINGS

Appendices and/or drawings illustrating various, non-limiting, example, innovative aspects of the Insulated Account Datastructure Apparatuses, Methods and Systems (hereinafter “IAD”) disclosure, include:

FIGS. 1A-1D show a datagraph diagram illustrating embodiments of a data flow for the IAD;

FIG. 2 shows a logic flow diagram illustrating embodiments of a custodial account configuring (CAC) component for the IAD;

FIG. 3 shows a logic flow diagram illustrating embodiments of a parent funds deposit processing (PFDP) component for the IAD;

FIG. 4 shows a logic flow diagram illustrating embodiments of a child funds deposit processing (CFDP) component for the IAD;

FIG. 5 shows a logic flow diagram illustrating embodiments of a purchase request processing (PRP) component for the IAD;

FIG. 6 shows a logic flow diagram illustrating embodiments of an investment request processing (IRP) component for the IAD;

FIG. 7 shows a screenshot diagram illustrating embodiments of the IAD;

FIG. 8 shows a screenshot diagram illustrating embodiments of the IAD;

FIG. 9 shows a screenshot diagram illustrating embodiments of the IAD;

FIG. 10 shows a screenshot diagram illustrating embodiments of the IAD;

FIG. 11 shows a screenshot diagram illustrating embodiments of the IAD;

FIG. 12 shows a screenshot diagram illustrating embodiments of the IAD;

FIG. 13 shows a screenshot diagram illustrating embodiments of the IAD;

FIG. 14 shows a screenshot diagram illustrating embodiments of the IAD;

FIG. 15 shows a screenshot diagram illustrating embodiments of the IAD;

FIG. 16 shows a screenshot diagram illustrating embodiments of the IAD; and

FIG. 17 shows a block diagram illustrating embodiments of a IAD controller.

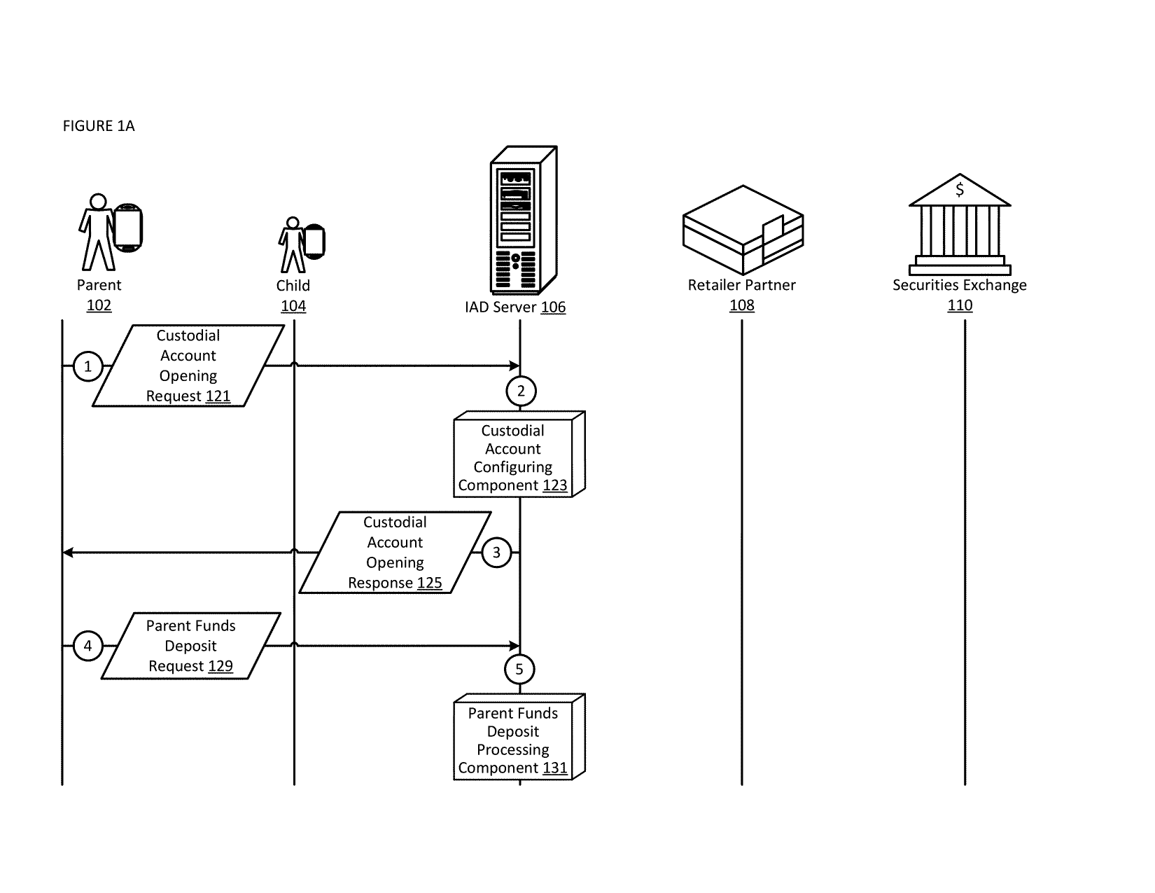

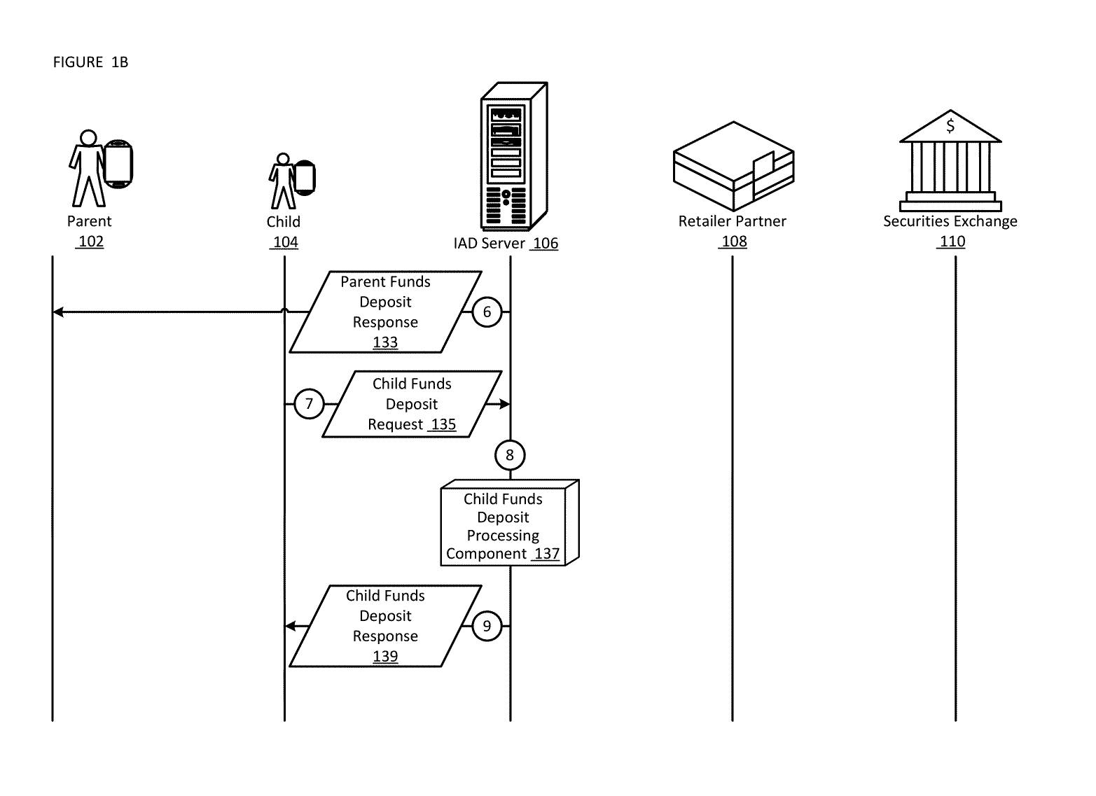

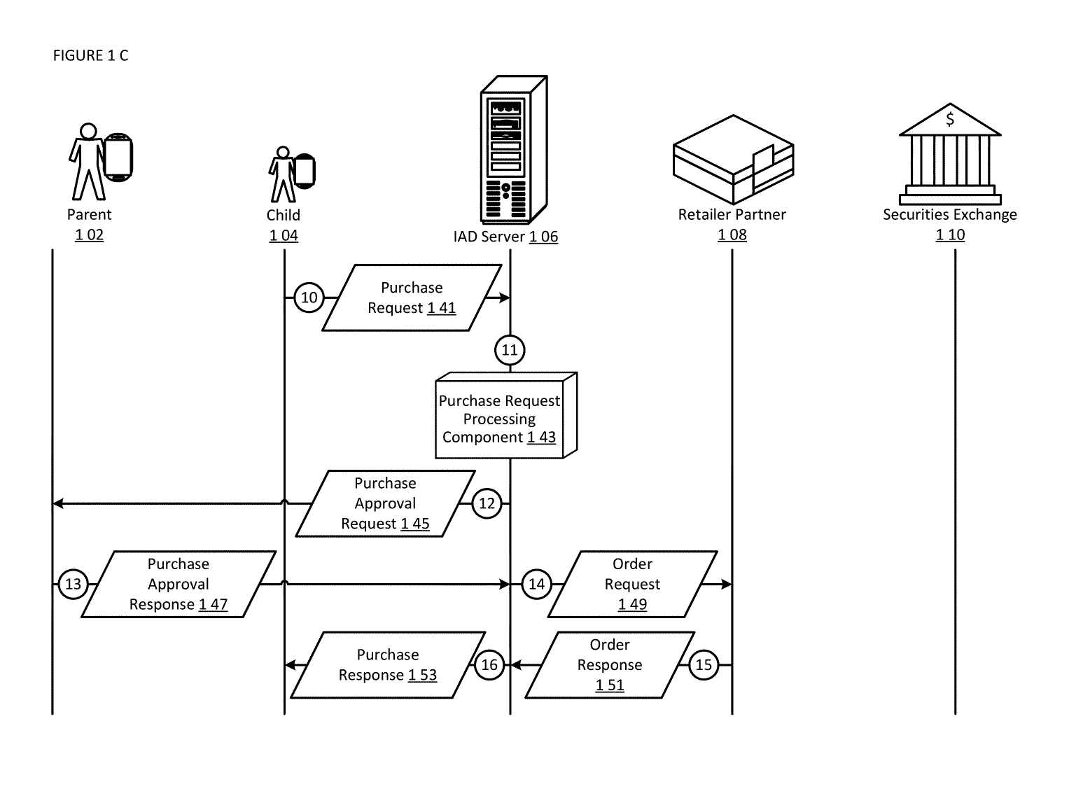

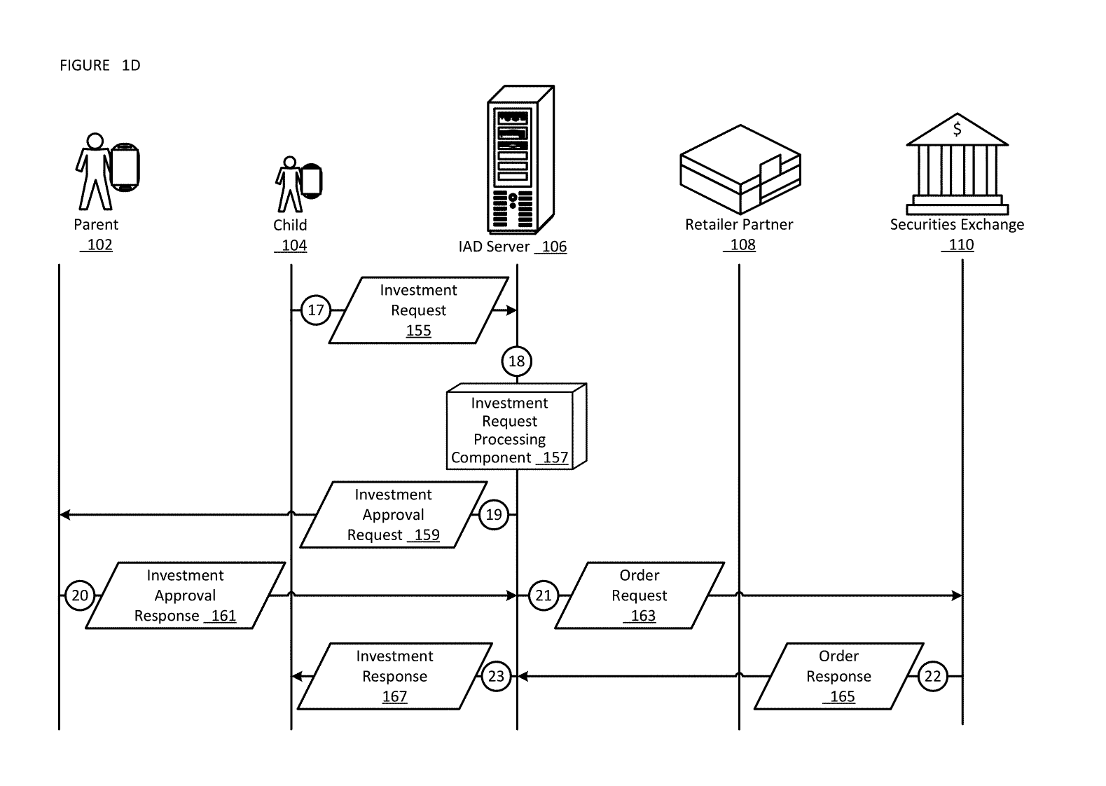

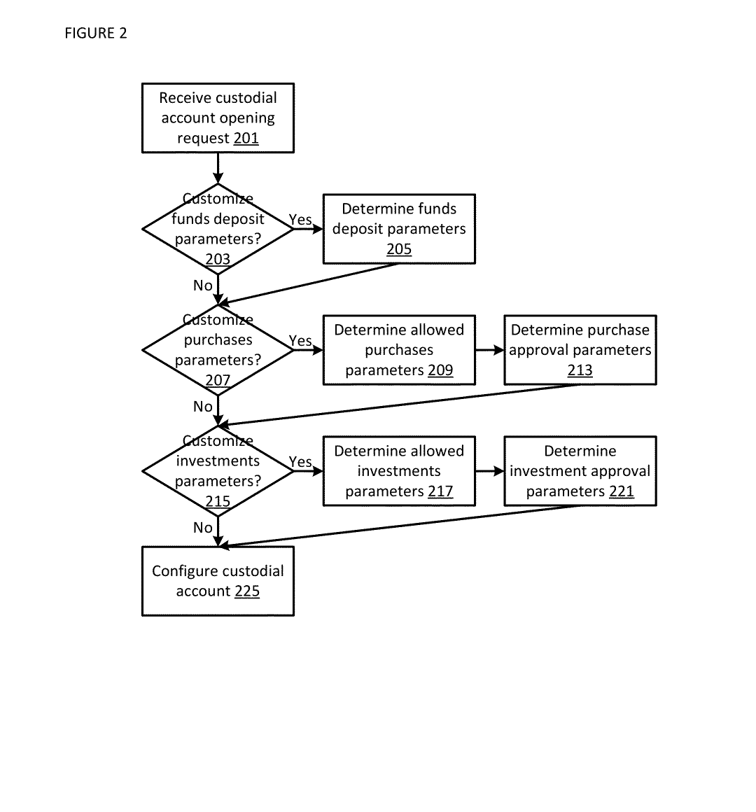

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Insulated Account Datastructure Apparatuses, Methods and Systems (hereinafter “IAD”) transforms purchase request and investment request inputs, via IAD components (e.g., CAC, PFDP, CFDP, PRP, IRP, etc.), into order request, purchase response, and investment response outputs. The IAD components, in various embodiments, implement advantageous features as set forth below.

### Introduction

Brokerage accounts are utilized by adults to invest in securities such as stocks, exchange traded funds (ETFs), bonds, and/or the like. Some brokerage accounts are custodial accounts that are utilized by an adult (e.g., a parent) to invest in securities for the benefit of a beneficiary (e.g., a child). The parent is a custodian who manages such a custodial account (e.g., a Uniform Gifts to Minors Act (UGMA) account or a Uniform Transfers To Minors Act (UTMA) account).

The IAD facilitates teaching children (e.g., teenagers) financial literacy and fiscal responsibility in an accessible manner through active money management while ensuring the children's safety and preserving their privacy.

A parent may utilize the IAD to open a custodial account for a child that may be funded with real money. The parent may control how the child's money is allocated between spending money and investing money, and/or how the child may spend and/or invest the child's money. Approved investment requests received from the child may be transformed by the IAD into securities orders placed by the parent.

### IAD

FIGS. 1A-1D show a datagraph diagram illustrating embodiments of a data flow for the IAD. In FIGS. 1A-1D, a parent 102 may send a custodial account opening request 121 to a IAD server 106. For example, the parent may use a client device (e.g., a desktop, a laptop, a tablet, a smartphone) to access IAD website, mobile app, and/or the like to facilitate generating the custodial account opening request. In one implementation, the custodial account opening request may include data such as a request identifier, a user identifier, a password, parent's personal data, child's personal data, funds deposit parameters, purchases parameters, investments parameters, and/or the like. For example, the custodial account opening request may be formatted according to the eXtensible Markup Language (XML). An example custodial account opening request, substantially in the form of a (Secure) Hypertext Transfer Protocol (HTTP(S)) POST message including XML-formatted data, is provided below:

POST /custodial_account_opening_request.php HTTP/1.1
Host: www.server.com
Content-Type: Application/XML
Content-Length: 667
<?XML version = “1.0” encoding = “UTF-8”?>
<custodial_account_opening_request>

<request_identifier>ID_request_1</request_identifier>
<user_identifier>ID_Parent</user_identifier>
<password>********</password>
<custodian_data>

<name>parent's name</name>
<DOB>parent's date of birth</DOB>
<contact_info>parent's email, phone, address</contact_info>

</custodian_data>
<beneficiary_data>

<name>child's name</name>
<DOB>child's date of birth</DOB>
<contact_info>child's email, phone, address</contact_info>

</beneficiary_data>
<funds_deposit_parameters>

<deposits_by_child>allowed</deposits_by_child>
<default_funds_allocations>50% purchases, 50%

investments</default_funds_allocations>

<custom_allocation_by_child>disallowed</custom_allocation_by_child>
<default_investment>none</default_investment>

</funds_deposit_parameters>
<purchases_parameters>

<allowed_retailers>all</allowed_retailers>
<obtain_purchase_approval>no</obtain_purchase_approval>

</purchases_parameters>
<investments_parameters>

<allowed_investments>S&P 500 ETF, NYSE:UA</allowed_investments>
<obtain_investment_approval>yes</obtain_investment_approval>
<price_swing_protection>10%</price_swing_protection>

</investments_parameters>

</custodial_account_opening_request>

The custodial account opening request may instruct the IAD server to open and/or configure a custodial account for the parent's child, who may be the beneficiary of the custodial account. The custodial account opening request may be processed by a custodial account configuring (CAC) component 123. See FIG. 2 for additional details regarding the CAC component.

The IAD server may send a custodial account opening response 125 to the parent. In one implementation, the IAD server may send webpage data, mobile app data and/or the like confirming that the custodial account has been opened and/or requesting additional and/or corrected information from the parent. For example, the custodial account opening response may be formatted according to the XML. An example custodial account opening response, substantially in the form of a HTTP(S) POST message including XML-formatted data, is provided below:

POST /custodial_account_opening_response.php HTTP/1.1
Host: www.server.com
Content-Type: Application/XML
Content-Length: 667
<?XML version = “1.0” encoding = “UTF-8”?>
<custodial_account_opening_response>

<response_identifier>ID_response_1</response_identifier>
<status>OK</status>
<custodial_account_number>account
number</custodial_account_number>

</custodial_account_opening_response>

In one embodiment, the parent may send a parent funds deposit request 129 to the IAD server. For example, the parent may send the parent funds deposit request to deposit funds into the custodial account. In one implementation, the parent funds deposit request may include data such as a request identifier, payment data, the child's custodial account number, deposit type, deposit conditions, deposit funds allocation, and/or the like. For example, the parent funds deposit request may be formatted according to the XML. An example parent funds deposit request, substantially in the form of a HTTP(S) POST message including XML-formatted data, is provided below:

POST /parent_funds_deposit_request.php HTTP/1.1
Host: www.server.com
Content-Type: Application/XML
Content-Length: 667
<?XML version = “1.0” encoding = “UTF-8”?>
<parent_funds_deposit_request>

<request_identifier>ID_request_2</request_identifier>
<payment_data>

<amount>$20</amount>
<payment_type>transfer from another account</payment_type>
<payment_account>account number</payment_account>

</payment_data>
<custodial_account_number>account
number</custodial_account_number>
<deposit_type>conditional</deposit_type>
<deposit_conditions>cut grass</deposit_conditions>
<deposit_funds_allocations>default</deposit_funds_allocations>

</parent_funds_deposit_request>

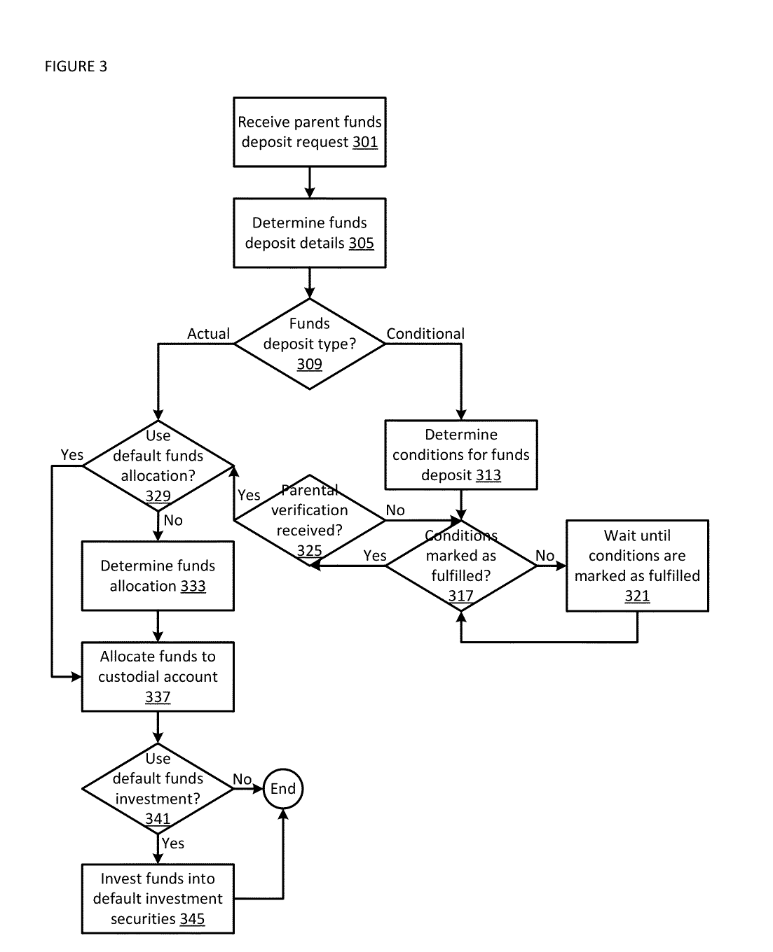

The parent funds deposit request may instruct the IAD server to deposit money into the custodial account. The parent funds deposit request may be processed by a parent funds deposit processing (PFDP) component 131. See FIG. 3 for additional details regarding the PFDP component.

The IAD server may send a parent funds deposit response 133 to the parent. The parent funds deposit response may be used to inform the parent that the request to deposit funds into the custodial account has been processed. For example, the parent funds deposit response may be formatted according to the XML. An example parent funds deposit response, substantially in the form of a HTTP(S) POST message including XML-formatted data, is provided below:

POST /parent_funds_deposit_response.php HTTP/1.1
Host: www.server.com
Content-Type: Application/XML
Content-Length: 667
<?XML version = “1.0” encoding = “UTF-8”?>
<parent_funds_deposit_response>

<response_identifier>ID_response_2</response_identifier>
<status>OK</status>

</parent_funds_deposit_response>

In one embodiment, the child 104 may send a child funds deposit request 135 to the IAD server. For example, the child may send the child funds deposit request to deposit funds into the custodial account. In one implementation, the child funds deposit request may include data such as a request identifier, payment data, the child's custodial account number, deposit funds allocation, and/or the like. For example, the child funds deposit request may be formatted according to the XML. An example child funds deposit request, substantially in the form of a HTTP(S) POST message including XML-formatted data, is provided below:

POST /child_funds_deposit_request.php HTTP/1.1
Host: www.server.com
Content-Type: Application/XML
Content-Length: 667
<?XML version = “1.0” encoding = “UTF-8”?>
<child_funds_deposit_request>

<request_identifier>ID_request_3</request_identifier>
<payment_data>

<amount>$10</amount>
<payment_type>mobile check deposit</payment_type>
<payment_details>check details</payment_details>

</payment_data>
<custodial_account_number>account
number</custodial_account_number>
<deposit_funds_allocations>>$3 purchases, $7

investments</deposit_funds_allocations>
</child_funds_deposit_request>

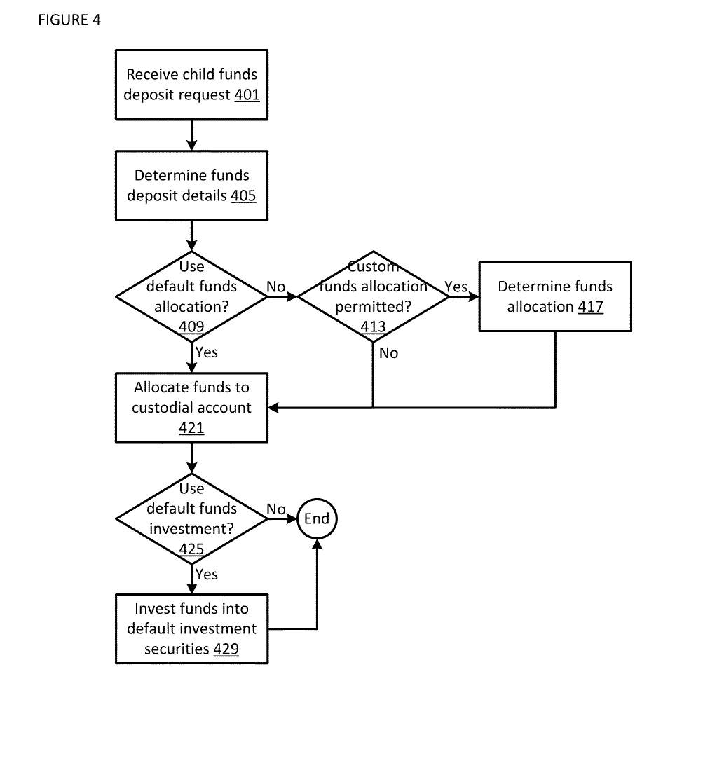

The child funds deposit request may instruct the IAD server to deposit money into the custodial account. The child funds deposit request may be processed by a child funds deposit processing (CFDP) component 137. See FIG. 4 for additional details regarding the CFDP component.

The IAD server may send a child funds deposit response 139 to the child. The child funds deposit response may be used to inform the child that the request to deposit funds into the custodial account has been processed. For example, the child funds deposit response may be formatted according to the XML. An example child funds deposit response, substantially in the form of a HTTP(S) POST message including XML-formatted data, is provided below:

POST /child_funds_deposit_response.php HTTP/1.1
Host: www.server.com
Content-Type: Application/XML
Content-Length: 667
<?XML version = “1.0” encoding = “UTF-8”?>
<child_funds_deposit_response>

<response_identifier>ID_response_3</response_identifier>
<status>OK</status>

</child_funds_deposit_response>

In one embodiment, the child may send a purchase request 141 to the IAD server. For example, the child may send the purchase request to buy a product or a service (e.g., a movie on iTunes, a bike on Amazon). In one implementation, the purchase request may include data such as a request identifier, the child's custodial account number, a retailer partner identifier, an item identifier, a quantity, a price, and/or the like. For example, the purchase request may be formatted according to the XML. An example purchase request, substantially in the form of a HTTP(S) POST message including XML-formatted data, is provided below:

POST /purchase_request.php HTTP/1.1
Host: www.server.com
Content-Type: Application/XML
Content-Length: 667
<?XML version = “1.0” encoding = “UTF-8”?>
<purchase_request>

<request_identifier>ID_request_4</request_identifier>
<custodial_account_number>account
number</custodial_account_number>
<retailer> iTunes</retailer>
<item>The Lego Movie</item>
<quantity>1</quantity>
<price>$19.99</price>

</purchase_request>

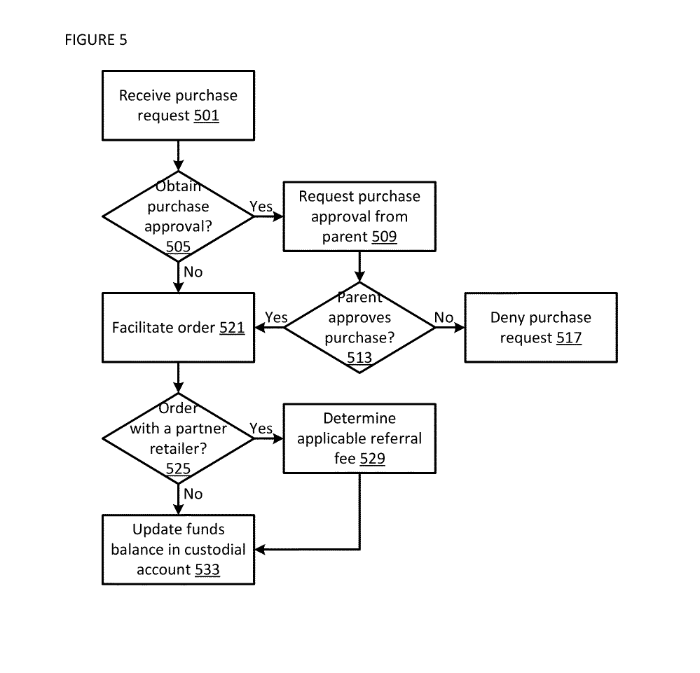

The purchase request may instruct the IAD server to request the parent's approval for the purchase and/or to facilitate the purchase order. The purchase request may be processed by a purchase request processing (PRP) component 143. See FIG. 5 for additional details regarding the PRP component.

The IAD server may send a purchase approval request 145 to the parent. For example, the IAD server may send the purchase approval request to confirm that the parent approves the purchase. In one implementation, the purchase approval request may include data such as a request identifier, the child's custodial account number, the child's name, a retailer partner identifier, an item identifier, a quantity, a price, and/or the like. For example, the purchase approval request may be formatted according to the XML. An example purchase approval request, substantially in the form of a HTTP(S) POST message including XML-formatted data, is provided below:

POST /purchase_approval_request.php HTTP/1.1
Host: www.server.com
Content-Type: Application/XML
Content-Length: 667
<?XML version = “1.0” encoding = “UTF-8”?>
<purchase_approval_request>

<request_identifier>ID_request_5</request_identifier>
<custodial_account_number>account
number</custodial_account_number>
<child_name>Manny</child_name>
<retailer> iTunes</retailer>
<item>The Lego Movie</item>
<quantity>1</quantity>
<price>$19.99</price>

</purchase_approval_request>

The parent may send a purchase approval response 147 to the IAD server. The purchase approval response may be used to indicate whether the parent approves the purchase. For example, the purchase approval response may be formatted according to the XML. An example purchase approval response, substantially in the form of a HTTP(S) POST message including XML-formatted data, is provided below:

POST /purchase_approval_response.php HTTP/1.1
Host: www.server.com
Content-Type: Application/XML
Content-Length: 667
<?XML version = “1.0” encoding = “UTF-8”?>
<purchase_approval_response>

<response_identifier>ID_response_5</response_identifier>
<status>Approved</status>

</purchase_approval_response>

The IAD server may send an order request 149 to a retailer partner 108. For example, the IAD server may send the order request to facilitate the purchase order. In one implementation, the order request may include data such as a request identifier, an advertising referrer identifier, an item identifier, a quantity, a price, payment data, contact information, and/or the like. For example, the order request may be formatted according to the XML. An example order request, substantially in the form of a HTTP(S) POST message including XML-formatted data, is provided below:

POST /order_request.php HTTP/1.1
Host: www.server.com
Content-Type: Application/XML
Content-Length: 667
<?XML version = “1.0” encoding = “UTF-8”?>
<order_request>

<request_identifier>ID_request_6</request_identifier>
<ad_referrrer_identifier>ID_FP_owner</ ad_referrrer_identifier>
<item>The Lego Movie</item>
<quantity>1</quantity>
<price>$19.99</price>
<payment_data>

<payment_type>payment from custodial
account</payment_type>
<custodial_account_number>account
number</custodial_account_number>

</payment_data>
<contact_info>parent's or child's email, phone,
address</contact_info>

</order_request>

The retailer partner may send an order response 151 to the IAD server. The order response may be used to inform the IAD server that the order has been processed. For example, the order response may be formatted according to the XML. An example order response, substantially in the form of a HTTP(S) POST message including XML-formatted data, is provided below:

POST /order_response.php HTTP/1.1
Host: www.server.com
Content-Type: Application/XML
Content-Length: 667
<?XML version = “1.0” encoding = “UTF-8”?>
<order_response>

<response_identifier>ID_response_6</response_identifier>
<status>OK</status>

</order_response>

The IAD server may send a purchase response 153 to the child. The purchase response may be used to inform the child that the order has been processed. For example, the purchase response may be formatted according to the XML. An example purchase response, substantially in the form of a HTTP(S) POST message including XML-formatted data, is provided below:

POST /purchase_response.php HTTP/1.1
Host: www.server.com
Content-Type: Application/XML
Content-Length: 667
<?XML version = “1.0” encoding = “UTF-8”?>
<purchase_response>

<response_identifier>ID_response_4</response_identifier>
<status>OK</status>

</purchase_response>

In one embodiment, the child may send an investment request 155 to the IAD server. For example, the child may send the investment request to invest in a security (e.g., a stock, a bond, an ETF). In one implementation, the investment request may include data such as a request identifier, the child's custodial account number, a security identifier, a quantity, a price, and/or the like. For example, the investment request may be formatted according to the XML. An example investment request, substantially in the form of a HTTP(S) POST message including XML-formatted data, is provided below:

POST /investment_request.php HTTP/1.1
Host: www.server.com
Content-Type: Application/XML
Content-Length: 667
<?XML version = “1.0” encoding = “UTF-8”?>
<investment_request>

<request_identifier>ID_request_7</request_identifier>
<custodial_account_number>account
number</custodial_account_number>
<security>NYSE:UA</security>
<quantity>1</quantity>
<price>$53</price>

</investment_request>

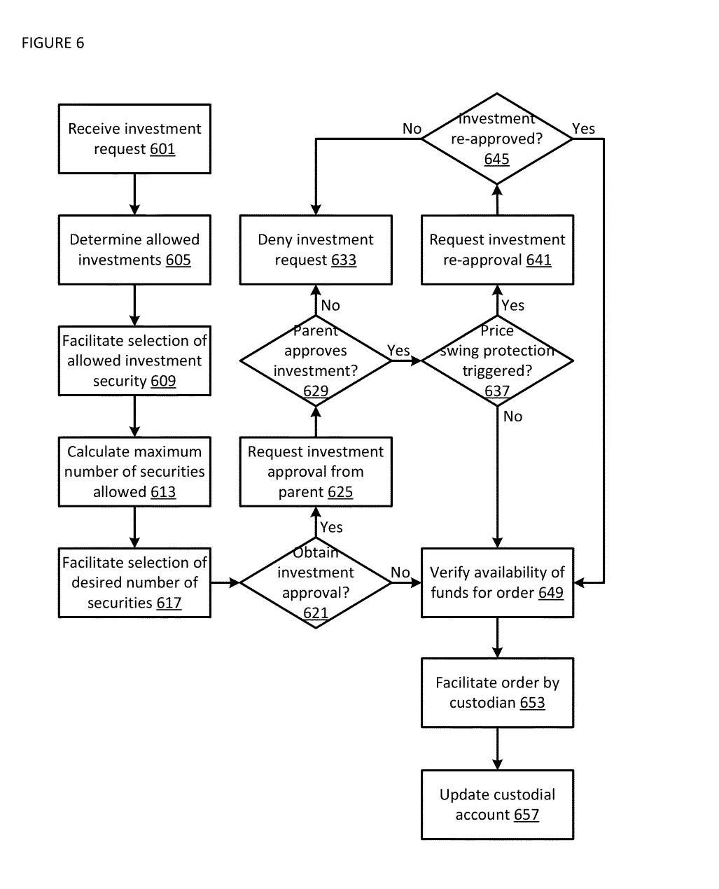

The investment request may instruct the IAD server to request the parent's approval for the investment and/or to facilitate the securities order. The investment request may be processed by an investment request processing (IRP) component 157. See FIG. 6 for additional details regarding the IRP component.

The IAD server may send an investment approval request 159 to the parent. For example, the IAD server may send the investment approval request to confirm that the parent approves the investment. In one implementation, the investment approval request may include data such as a request identifier, the child's custodial account number, the child's name, a security identifier, a quantity, a price, and/or the like. For example, the purchase approval request may be formatted according to the XML. An example investment approval request, substantially in the form of a HTTP(S) POST message including XML-formatted data, is provided below:

POST /investment_approval_request.php HTTP/1.1
Host: www.server.com
Content-Type: Application/XML
Content-Length: 667
<?XML version = “1.0” encoding = “UTF-8”?>
<investment_approval_request>

<request_identifier>ID_request_8</request_identifier>
<custodial_account_number>account
number</custodial_account_number>
<child_name>Manny</child_name>
<security>NYSE:UA</security>
<quantity>1</quantity>
<price>$53</price>

</investment_approval_request>

The parent may send an investment approval response 161 to the IAD server. The investment approval response may be used to indicate whether the parent approves the investment. For example, the investment approval response may be formatted according to the XML. An example investment approval response, substantially in the form of a HTTP(S) POST message including XML-formatted data, is provided below:

POST /investment_approval_response.php HTTP/1.1
Host: www.server.com
Content-Type: Application/XML
Content-Length: 667
<?XML version = “1.0” encoding = “UTF-8”?>
<investment_approval_response>

<response_identifier>ID_response_8</response_identifier>
<status>Approved</status>

</investment_approval_response>

The IAD server may send an order request 163 to a securities exchange 110. For example, the IAD server may send the order request to facilitate the securities order. In one implementation, the order request may include data such as a request identifier, a security identifier, a quantity, a price, payment data, contact information, and/or the like. For example, the order request may be formatted according to the XML. An example order request, substantially in the form of a HTTP(S) POST message including XML-formatted data, is provided below:

POST /order_request.php HTTP/1.1
Host: www.server.com
Content-Type: Application/XML
Content-Length: 667
<?XML version = “1.0” encoding = “UTF-8”?>
<order_request>

<request_identifier>ID_request_9</request_identifier>
<security>NYSE:UA</security>
<quantity>1</quantity>
<price>$53</price>
<payment_data>

<payment_type>payment from custodial
account</payment_type>
<custodial_account_number>account
number</custodial_account_number>

</payment_data>
<contact_info>parent’s email, phone, address</contact_info>

</order_request>

The securities exchange may send an order response 165 to the IAD server. The order response may be used to inform the IAD server that the order has been processed. For example, the order response may be formatted according to the XML. An example order response, substantially in the form of a HTTP(S) POST message including XML-formatted data, is provided below:

POST /order_response.php HTTP/1.1
Host: www.server.com
Content-Type: Application/XML
Content-Length: 667
<?XML version = “1.0” encoding = “UTF-8”?>
<order_response>

<response_identifier>ID_response_9</response_identifier>
<status>OK</status>

</order_response>

The IAD server may send an investment response 167 to the child. The investment response may be used to inform the child that the order has been processed. For example, the investment response may be formatted according to the XML. An example investment response, substantially in the form of a HTTP(S) POST message including XML-formatted data, is provided below:

POST /investment_response.php HTTP/1.1
Host: www.server.com
Content-Type: Application/XML
Content-Length: 667
<?XML version = “1.0” encoding = “UTF-8”?>
<investment_response>

<response_identifier>ID_response_7</response_identifier>
<status>OK</status>

</investment_response>

FIG. 2 shows a logic flow diagram illustrating embodiments of a custodial account configuring (CAC) component for the IAD. In FIG. 2, a custodial account opening request may be received at 201. For example, a parent may wish to open a custodial account for a child. Accordingly, the custodial account opening request may be received from a custodial account opening webpage or mobile app screen of the IAD utilized by the parent via a client device.

A determination may be made at 203 whether funds deposit parameters for the custodial account should be customized. In one implementation, data returned by the custodial account opening webpage or mobile app screen to a IAD server may be parsed (e.g., using PHP commands) to determine whether the funds deposit parameters should be customized. For example, the parent may wish to utilize default funds deposit parameters. In another example, the parent may wish to customize funds deposit parameters.

If it is determined that the funds deposit parameters should be customized, specified funds deposit parameters may be determined at 205. In one implementation, data returned by the custodial account opening webpage or mobile app screen to the IAD server may be parsed (e.g., using PHP commands) to determine the specified funds deposit parameters. For example, the specified funds deposit parameters may indicate whether funds deposits by the child are allowed, what should be the default funds allocation (e.g., the percentage or amount that may be used for purchases, the percentage or amount that may be used for investments) when funds are deposited, whether the child is allowed to change the default funds allocation (e.g., for funds deposits made by the child), whether there is a default investment (e.g., newly deposited funds may be automatically invested into a S&P 500 ETF until the child decides to invest into a different security).

A determination may be made at 207 whether purchases parameters for the custodial account should be customized. In one implementation, data returned by the custodial account opening webpage or mobile app screen to the IAD server may be parsed (e.g., using PHP commands) to determine whether the purchases parameters should be customized. For example, the parent may wish to utilize default purchases parameters. In another example, the parent may wish to customize purchases parameters.

If it is determined that the purchases parameters should be customized, specified allowed purchases parameters may be determined at 209 and/or specified purchase approval parameters may be determined at 213. In one implementation, data returned by the custodial account opening webpage or mobile app screen to the IAD server may be parsed (e.g., using PHP commands) to determine the specified allowed purchases parameters and/or the specified purchase approval parameters. For example, the specified allowed purchases parameters may indicate from which retailers the child may purchase products and/or services. For example, the specified purchase approval parameters may indicate whether the child's purchases should be approved by the parent.

A determination may be made at 215 whether investments parameters for the custodial account should be customized. In one implementation, data returned by the custodial account opening webpage or mobile app screen to the IAD server may be parsed (e.g., using PHP commands) to determine whether the investments parameters should be customized. For example, the parent may wish to utilize default investments parameters. In another example, the parent may wish to customize investments parameters.

If it is determined that the investments parameters should be customized, specified allowed investments parameters may be determined at 217 and/or specified investment approval parameters may be determined at 221. In one implementation, data returned by the custodial account opening webpage or mobile app screen to the IAD server may be parsed (e.g., using PHP commands) to determine the specified allowed investments parameters and/or the specified investment approval parameters. For example, the specified allowed investments parameters may indicate into which securities the child may invest. For example, the specified investment approval parameters may indicate whether the child's investments should be approved by the parent.

The custodial account may be configured in accordance with the determined parameters at 225. In some implementations, configuration data associated with the custodial account may be stored via a MySQL database command similar to the following:

INSERT INTO CustodialAccounts (custodial_account_number,
funds_deposit_parameters,

purchases_parameters, investments_parameters)

VALUES (“account number”, “funds deposit parameters”,
“allowed purchases
parameters and/or purchase

approval parameters”, “allowed investments parameters and/or

investment approval

parameters”);

FIG. 3 shows a logic flow diagram illustrating embodiments of a parent funds deposit processing (PFDP) component for the IAD. In FIG. 3, a parent funds deposit request may be received at 301. For example, the parent may wish to deposit funds into a child's custodial account. Accordingly, the parent funds deposit request may be received via a parent funds deposit webpage or mobile app screen of the IAD utilized by the parent via a client device.

Funds deposit details associated with the funds deposit may be determined at 305. In one implementation, the parent funds deposit request may be parsed (e.g., using PHP commands) to determine payment data associated with the funds deposit. For example, payment data may include the amount of the funds deposit (e.g., $20), the payment method (e.g., transfer from another account, credit card, check), the account number associated with the payment method (e.g., the parent's account number).

A determination may be made at 309 regarding the type of the funds deposit. For example, the funds deposit may be an actual deposit (e.g., money should be transferred into the custodial account upon processing the request) or a conditional deposit (e.g., money should be transferred into the custodial account upon fulfillment of specified conditions). In one implementation, the parent funds deposit request may be parsed (e.g., using PHP commands) to determine the type of the funds deposit.

If it is determined that the funds deposit is conditional, conditions for the funds deposit may be determined at 313. In one implementation, the parent funds deposit request may be parsed (e.g., using PHP commands) to determine conditions associated with the funds deposit. For example, conditions may include performing a task (e.g., cut the grass, wash the car), academic achievements (e.g., achieving an A- or above grade point average), investment achievements (e.g., put a specified minimum amount towards investments, earn a specified minimum return on investments).

A determination may be made whether conditions for the funds deposit have been marked as fulfilled at 317. For example, the child may mark the conditions as having been fulfilled using a webpage or mobile app screen of the IAD via the child's client device. If the child did not mark the conditions as having been fulfilled, the IAD may wait until the conditions are marked as fulfilled at 321.

If the child did mark the conditions as having been fulfilled, a determination may be made at 325 whether parental verification was received. In one implementation, upon determining that the conditions have been marked as fulfilled by the child, the IAD may send a notification (e.g., an email, a mobile app message) to the parent and/or prompt the parent to confirm that the conditions have been fulfilled. If parental verification is received or if it is determined that the funds deposit is an actual deposit, the funds may be deposited into the custodial account.

A determination may be made at 329 whether to use default funds allocation for the funds deposit. In one implementation, the parent funds deposit request may be parsed (e.g., using PHP commands) to determine whether the parent specified an alternative funds allocation for the funds deposit.

If it is determined that the default funds allocation should not be used for the funds deposit, alternative funds allocation may be determined at 333. In one implementation, the parent funds deposit request may be parsed (e.g., using PHP commands) to determine the alternative funds allocation specified by the parent.

Funds may be allocated to the custodial account at 337. In one implementation, funds may be allocated in accordance with the determined funds allocation. For example, if the determined funds allocation indicates that 50% of the funds should be allocated to purchases and 50% of the funds should be allocated to investments, then $10 of a $20 funds deposit may be allocated to purchases and $10 may be allocated to investments. In some implementations, a notification (e.g., an email, a mobile app message) may be sent to the parent and/or to the child to inform the parent and/or the child that the funds have been allocated to the custodial account.

A determination may be made at 341 whether to use default funds investment for the funds deposit. In one implementation, funds deposit parameters associated with the custodial account may be checked to determine whether to use default funds investment. For example, the default investment securities associated with the custodial account may be determined via a MySQL database command similar to the following:

SELECT default_investment
FROM CustodialAccounts
WHERE custodial_account_number = “account number”;

If it is determined that default funds investment should be used for the funds deposit, the portion of the funds deposit allocated to investments (e.g., $10) may be invested (e.g., by placing an order via a securities exchange) into the default investment securities (e.g., S&P 500 ETF) at 345. In some implementations, a minimum amount of available funds may have to be available for investments in the custodial account before the funds are invested into the default investment securities. In some implementations, a notification (e.g., an email, a mobile app message) may be sent to the parent and/or to the child to inform the parent and/or the child that the funds have been invested into the default investment securities.

FIG. 4 shows a logic flow diagram illustrating embodiments of a child funds deposit processing (CFDP) component for the IAD. In FIG. 4, a child funds deposit request may be received at 401. For example, the child may wish to deposit funds into the child's custodial account. Accordingly, the child funds deposit request may be received via a child funds deposit webpage or mobile app screen of the IAD utilized by the child via a client device.

Funds deposit details associated with the funds deposit may be determined at 405. In one implementation, the child funds deposit request may be parsed (e.g., using PHP commands) to determine payment data associated with the funds deposit. For example, payment data may include the amount of the funds deposit (e.g., $20), the payment method (e.g., mobile check deposit), the account number associated with the payment method (e.g., check details).

A determination may be made at 409 whether to use default funds allocation for the funds deposit. In one implementation, the child funds deposit request may be parsed (e.g., using PHP commands) to determine whether the child specified an alternative funds allocation for the funds deposit.

If it is determined that the child specified an alternative funds allocation for the funds deposit, a determination may be made at 413 whether custom funds allocation is permitted for the custodial account. For example, whether custom funds allocation is permitted for the custodial account may be determined via a MySQL database command similar to the following:

SELECT custom_allocation_by_child
FROM CustodialAccounts
WHERE custodial_account_number = “account number”;

If it is determined that custom funds allocation by the child is permitted for the custodial account, alternative funds allocation may be determined at 417. In one implementation, the child funds deposit request may be parsed (e.g., using PHP commands) to determine the alternative funds allocation specified by the child. If it is determined that custom funds allocation by the child is not permitted for the custodial account, the default funds allocation may be used.

Funds may be allocated to the custodial account at 421. In one implementation, funds may be allocated in accordance with the determined funds allocation. For example, if the determined funds allocation indicates that $10 of the funds should be allocated to purchases and the rest of the funds should be allocated to investments, then $10 of a $20 funds deposit may be allocated to purchases and $10 may be allocated to investments. In some implementations, a notification (e.g., an email, a mobile app message) may be sent to the child's parent and/or to the child to inform the parent and/or the child that the funds have been allocated to the custodial account.

A determination may be made at 425 whether to use default funds investment for the funds deposit. In one implementation, funds deposit parameters associated with the custodial account may be checked to determine whether to use default funds investment. For example, the default investment securities associated with the custodial account may be determined via a MySQL database command similar to the following:

SELECT default_investment
FROM CustodialAccounts
WHERE custodial_account_number = “account number”;

If it is determined that default funds investment should be used for the funds deposit, the portion of the funds deposit allocated to investments (e.g., $10) may be invested (e.g., by placing an order via a securities exchange) into the default investment securities (e.g., S&P 500 ETF) at 429. In some implementations, a minimum amount of available funds may have to be available for investments in the custodial account before the funds are invested into the default investment securities. In some implementations, a notification (e.g., an email, a mobile app message) may be sent to the parent and/or to the child to inform the parent and/or the child that the funds have been invested into the default investment securities.

FIG. 5 shows a logic flow diagram illustrating embodiments of a purchase request processing (PRP) component for the IAD. In FIG. 5, a purchase request may be received at 501. For example, a child may wish to purchase a product or a service using funds in the portion of the custodial account allocated to purchases (e.g., funds allocated for purchases may be stored in a checking account). Accordingly, the purchase request may be received via a purchase request webpage or mobile app screen of the IAD utilized by the child via a client device.

A determination may be made at 505 whether parental approval should be obtained for purchases. In one implementation, purchases parameters associated with the custodial account may be checked to determine whether to obtain purchase approval. For example, whether to obtain purchase approval for the custodial account may be determined via a MySQL database command similar to the following:

SELECT obtain_purchase_approval
FROM CustodialAccounts
WHERE custodial_account_number = “account number”;

If it is determined that purchase approval should be obtained for the custodial account, purchase approval may be requested from the child's parent at 509. In one implementation, a notification (e.g., an email, a mobile app message) may be sent to the parent to prompt the parent to indicate whether the parent approves the purchase. The parent's response may be analyzed at 513 to determine whether the parent approves the purchase. In one implementation, the parent's response (e.g., generated based on the parent clicking on an “Approve” button or on a “Reject” button) may be parsed (e.g., using PHP commands) to determine whether the parent approves the purchase. In some implementations, if the parent does not respond within a predetermined time period, the purchase request may be automatically allowed or rejected (e.g., depending on a configuration setting). If the parent rejects the purchase, the purchase request may be denied at 517. In one implementation, a notification (e.g., an email, a mobile app message) may be sent to the child to inform the child that the purchase request was denied.

If the parent approves the purchase, the IAD may facilitate the purchase order at 521. In one implementation, the order may be placed with a retailer associated with the purchase request. A determination may be made at 525 whether the order was placed with a partner retailer. For example, partner retailers may pay an advertising referral fee for orders originating via the IAD. If the order was placed with a partner retailer, applicable referral fee associated with the order may be determined at 529 (e.g., based on a fee schedule associated with the partner retailer). In some implementations, the IAD may invoice partner retailers in accordance with earned referral fees.

Funds balance associated with the custodial account may be updated at 533 to reflect the amount spent on the purchase. For example, the account balance of a checking account used to store funds allocated for purchases may be reduced by the amount associated with the purchase. Seeing the account balance decline when making purchases may help facilitate responsible spending by the child. In some implementations, a notification (e.g., an email, a mobile app message) may be sent to the parent and/or to the child to inform the parent and/or the child that the purchase order was placed and/or that the funds have been withdrawn (e.g., the notification may include the updated account balance).

FIG. 6 shows a logic flow diagram illustrating embodiments of an investment request processing (IRP) component for the IAD. In FIG. 6, an investment request may be received at 601. For example, a child may wish to invest into a security using funds in the portion of the custodial account allocated to investments (e.g., funds allocated for investments may be stored in a savings account). Accordingly, the investment request may be received via an investment request webpage or mobile app screen of the IAD utilized by the child via a client device.

Allowed investments associated with the custodial account may be determined at 605. For example, the child's parent may specify that the child is allowed to invest in a predetermined set of securities and/or security types (e.g., stocks, bonds, ETFs). In another example, the parent may specify that the child is allowed to invest into any security. In one implementation, investments parameters associated with the custodial account may be checked to determine into which investments the child is allowed to invest. For example, allowed investments for the custodial account may be determined via a MySQL database command similar to the following:

SELECT allowed_investments
FROM CustodialAccounts
WHERE custodial_account_number = “account number”;

The IAD may facilitate selection of an allowed investment security by the child at 609. For example, the IAD may facilitate selection of an allowed investment security from a list of allowed investment securities. In another example, the IAD may facilitate searching for securities that are allowed investment securities. In some implementation, the IAD may facilitate teaching the child financial literacy by showing an indication of the quality of a security in an accessible manner. For example, the IAD may show the child how professionals rate the security (e.g., 7 professionals give the security thumbs up and 3 professionals give the security thumbs down).

At 613, the IAD may calculate the maximum number of securities (e.g., shares) that may be bought by the child for securities that are of interest to the child. In one implementation, the maximum number of shares of a security that the child may buy may be calculated as the maximum number of shares that may be bought using funds in the portion of the custodial account allocated to investments after paying applicable transaction fees at the current per share price. For example, if the child has $120 and the transaction fee for purchasing shares of stock is $8, the child may spend up to $112 on stocks. If the NYSE:UA security costs $53 at the time of the calculation, the child has enough money to purchase up to 2 shares.

The IAD may facilitate selection of a desired number of securities (e.g., shares) for an allowed investment security by the child at 617. In one implementation, the child may select between one and the maximum number of shares of an allowed investment security via the IAD GUI. For example, the child may select the desired number of shares (e.g., 1 share) of a desired allowed investment security (e.g., NYSE:UA) to indicate that the child wishes to place a securities order for such security.

A determination may be made at 621 whether parental approval should be obtained for investments. In one implementation, investments parameters associated with the custodial account may be checked to determine whether to obtain investment approval. For example, whether to obtain investment approval for the custodial account may be determined via a MySQL database command similar to the following:

SELECT obtain_investment_approval
FROM CustodialAccounts
WHERE custodial_account_number = “account number”;

If it is determined that investment approval should be obtained for the custodial account, investment approval may be requested from the child's parent at 625. In one implementation, a notification (e.g., an email, a mobile app message) may be sent to the parent to prompt the parent to indicate whether the parent approves the investment. The parent's response may be analyzed at 629 to determine whether the parent approves the investment. In one implementation, the parent's response (e.g., generated based on the parent clicking on an “Approve” button or on a “Reject” button) may be parsed (e.g., using PHP commands) to determine whether the parent approves the investment. In some implementations, if the parent does not respond within a predetermined time period, the investment request may be automatically allowed or rejected (e.g., depending on a configuration setting). If the parent rejects the investment, the investment request may be denied at 633. In one implementation, a notification (e.g., an email, a mobile app message) may be sent to the child to inform the child that the investment request was denied.

If the parent approves the investment, a determination may be made at 637 whether price swing protection for the security selected by the child has been triggered. For example, if the price of the selected security increased or decreased by more than a predetermined amount (e.g., 10%) between the time that the child wished to place the securities order and the time that the parent approved such order, price swing protection may be triggered to prevent a potentially undesirable securities order from being placed. In one implementation, investments parameters associated with the custodial account may be checked to determine conditions (e.g., the price of a security changed by more than 10%, end of the trading day has been reached) under which price swing protection is triggered. For example, conditions under which price swing protection is triggered may be determined via a MySQL database command similar to the following:

SELECT price_swing_protection
FROM CustodialAccounts
WHERE custodial_account_number = “account number”;

If it is determined that price swing protection has been triggered, investment re-approval may be requested from the child and/or the parent at 641. In one implementation, notifications (e.g., an email, a mobile app message) may be sent to the child and/or the parent to prompt the child and/or the parent to indicate whether the child and/or the parent re-approve the investment. The child's and/or the parent's responses may be analyzed at 645 to determine whether the child and/or the parent re-approve the investment. In one implementation, the child's and/or the parent's responses (e.g., generated based on the child and/or the parent clicking on an “Approve” button or on a “Reject” button) may be parsed (e.g., using PHP commands) to determine whether the child and/or the parent approve the investment. In some implementations, if the child and/or the parent do not respond within a predetermined time period, the investment request may be automatically allowed or rejected (e.g., depending on a configuration setting). If the child and/or the parent reject the investment, the investment request may be denied at 633. In one implementation, a notification (e.g., an email, a mobile app message) may be sent to the child to inform the child that the investment request was denied.

If it is determined that investment approval should not be obtained or if the investment is approved and/or re-approved, the IAD may verify availability of funds for the securities order at 649. In one implementation, the IAD may verify that sufficient funds in the portion of the custodial account allocated to investments exist to pay for the securities order at the current price.

If there are sufficient funds, the IAD may facilitate the securities order at 653. In one implementation, the IAD transforms the investment request into a securities order placed by the custodian (e.g., the parent) associated with the custodial account. Configuring the securities order in such a way that it is placed by the custodian prevents creation of a public record of the child executing a trade. This ensures the child's safety and preserves the child's privacy, since trade activity appears as if being executed by the parent on the custodial account.

Funds balance associated with the custodial account may be updated at 657 to reflect the amount spent on the securities order. For example, the account balance of a savings account used to store funds allocated for investments may be reduced by the amount associated with the securities order. In another example, purchased securities may be added to the custodial account and their value may be used to calculate the total account balance of the portion of the custodial account allocated to investments. Learning how to invest into securities may help facilitate financial literacy of the child. In some implementations, a notification (e.g., an email, a mobile app message) may be sent to the parent and/or to the child to inform the parent and/or the child that the securities order was placed and/or that the funds have been withdrawn (e.g., the notification may include the updated account balance).

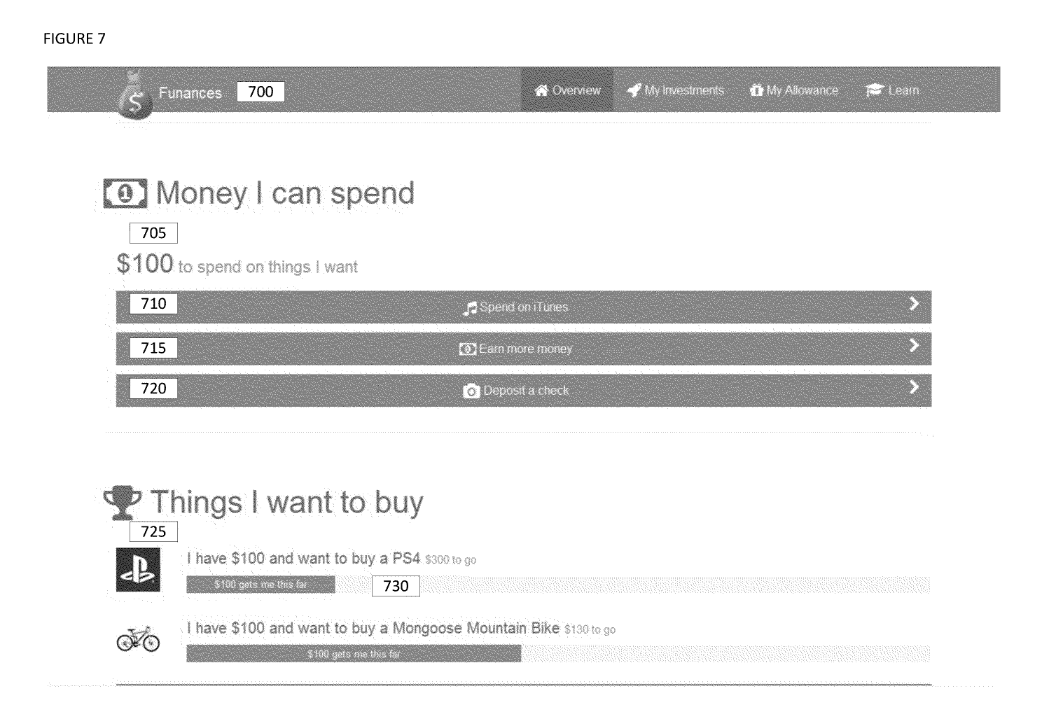

FIG. 7 shows a screenshot diagram illustrating embodiments of the IAD. In FIG. 7, an exemplary IAD webpage 700 that may be utilized by a child associated with a custodial account is shown. The “Money I can spend” section 705 shows that the custodial account has $100 allocated for purchases. The child may spend this money to purchase products and/or services. For example, the child may click on the “Spend on iTunes” button 710 to initiate a purchase request. The child may earn money for the custodial account (e.g., by performing a task, based on academic achievements, based on investment achievements). For example, the child may click on the “Earn more money” button 715 to mark a task (e.g., cut the grass) as completed. The child may deposit a check into the custodial account. For example, the child may click on the “Deposit a check” button 720 to initiate a child funds deposit request.

The “Things I want to buy” section 725 helps the child learn fiscal responsibility by facilitating setting goals. For example, if the child's goal is to buy a PS4, the progress meter may show the child how far along the child is to achieving this goal.

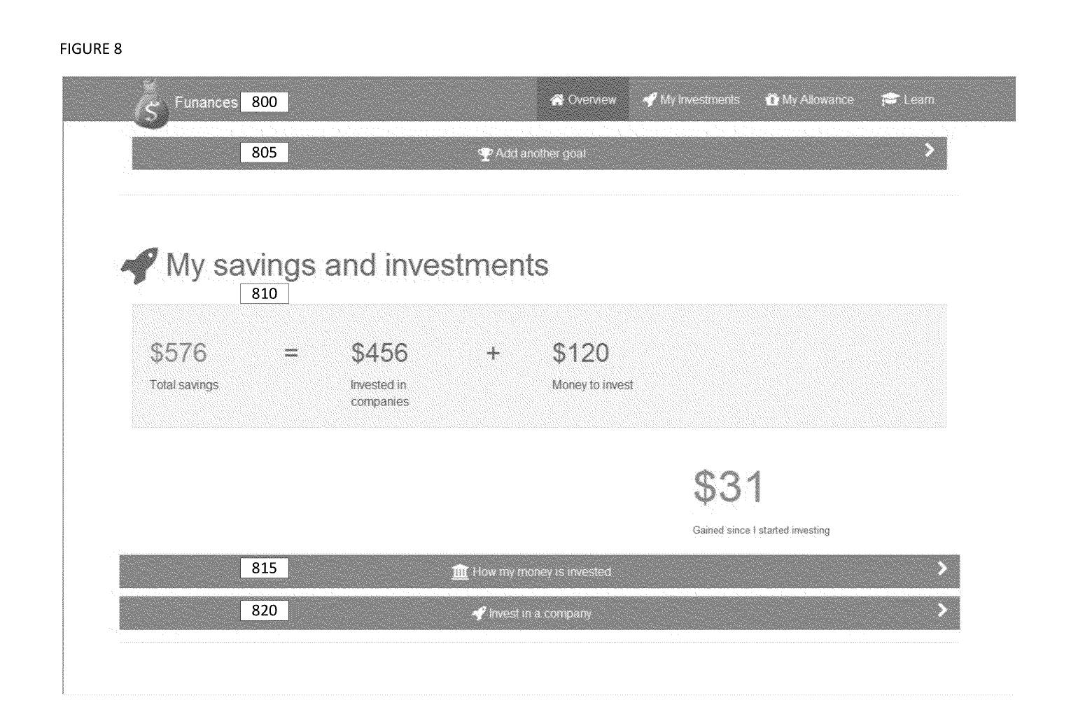

FIG. 8 shows a screenshot diagram illustrating embodiments of the IAD. In FIG. 8, an exemplary IAD webpage 800 is shown, which is a scrolled down view of the IAD webpage 700. Continuing with the “Things I want to buy” section 725, the child may click on the “Add another goal” button 805 to add another goal.

The “My savings and investments” section 810 shows that the custodial account has $576 allocated for investments. Of that money, $456 are invested in stocks of companies and $120 are available for the child to invest. The child gained $31 since the child started investing. Accordingly, the child may see the benefits of investing. The child may click on the “How my money is invested” button 815 to see a detailed explanation of how the child's money is invested (e.g., which company stocks and the number of shares in each stock). The child may click on the “Invest in a company” button 820 to initiate an investment request.

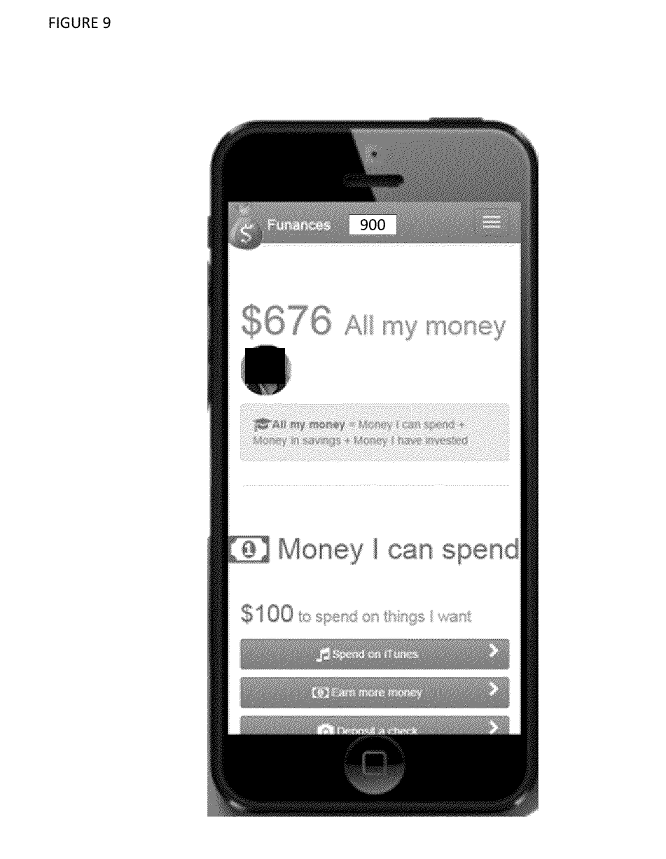

FIG. 9 shows a screenshot diagram illustrating embodiments of the IAD. In FIG. 9, an exemplary IAD mobile app 900 is shown. For example, the child may access the IAD mobile app via the child's iPhone. The IAD mobile app is an alternative way to IAD webpages 700 and 800 for the child to utilize the IAD.

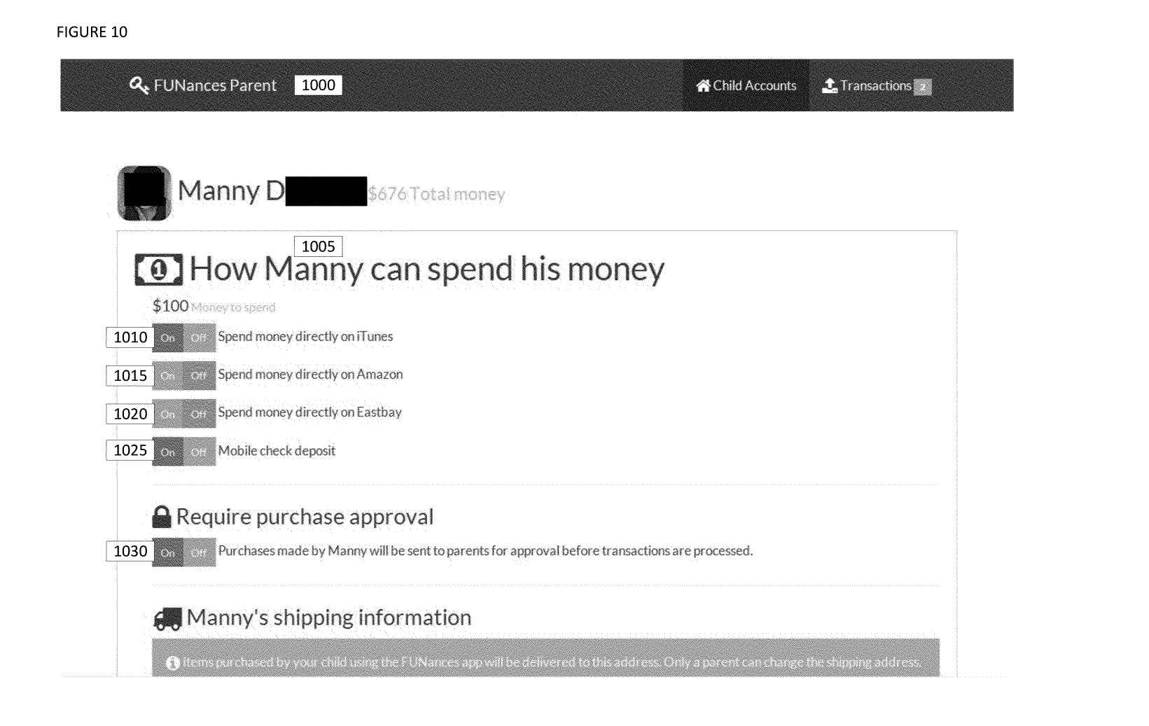

FIG. 10 shows a screenshot diagram illustrating embodiments of the IAD. In FIG. 10, an exemplary IAD webpage 1000 that may be utilized by a parent associated with a custodial account is shown. Alternatively, the parent may utilize a IAD mobile app. The “How Manny can spend his money” section 1005 facilitates specifying funds deposit parameters and/or purchases parameters for the custodial account associated with the parent's child (Manny). These and other parameters may be specified when opening the custodial account and/or changed at any time if the parent wishes to modify parameters settings. For example, the parent may use the “Spend money directly on iTunes” switch 1010 to specify whether the child is allowed to make purchases from iTunes (e.g., yes), the “Spend money directly on Amazon” switch 1015 to specify whether the child is allowed to make purchases from Amazon (e.g., no), and the “Spend money directly on Eastbay” switch 1020 to specify whether the child is allowed to make purchases from Eastbay (e.g., no) using the custodial account. In another example, the parent may use the “Mobile check deposit” switch 1025 to specify whether the child is allowed to make mobile check deposits into the custodial account (e.g., yes). In yet another example, the parent may use the “Require purchase approval” switch 1030 to specify whether parental approval should be obtained for purchases the child wishes to make using the custodial account (e.g., yes).

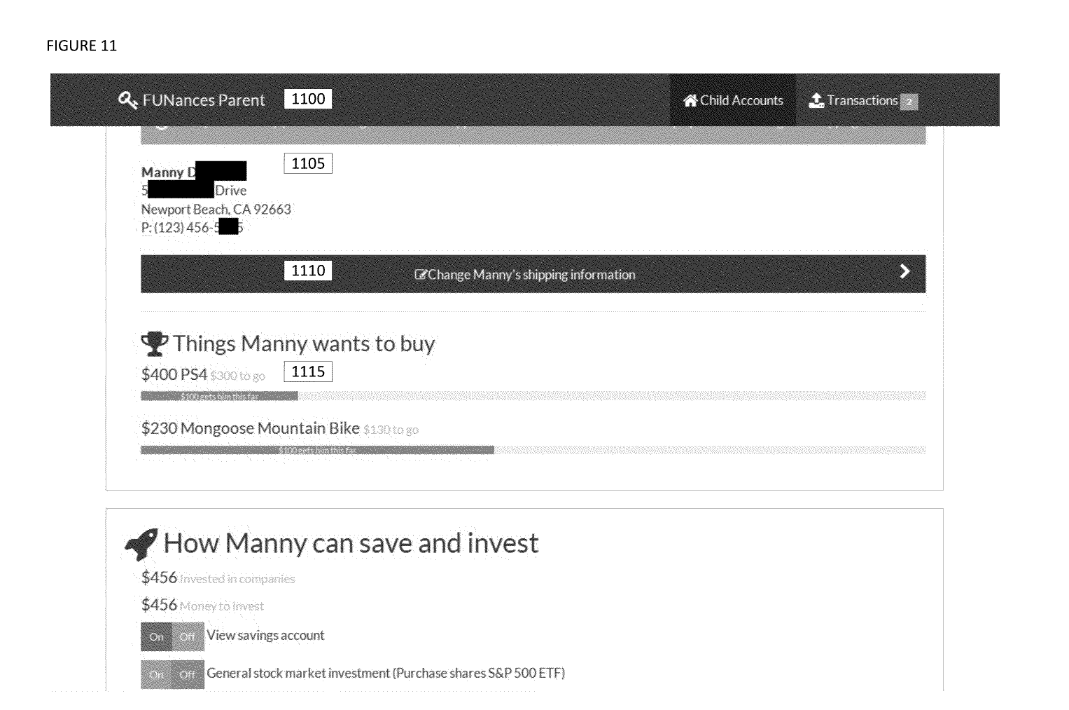

FIG. 11 shows a screenshot diagram illustrating embodiments of the IAD. In FIG. 11, an exemplary IAD webpage 1100 is shown, which is a scrolled down view of the IAD webpage 1000. Continuing with the “How Manny can spend his money” section 1005, the parent may view shipping information 1105 (e.g., provided to retailers when the child makes a purchase) associated with the custodial account. The parent may click on the “Change Manny's shipping information” button 1110 to change the shipping information associated with the custodial account. The parent may view goals 1115 that the child set and/or how far along the child is to achieving each goal.

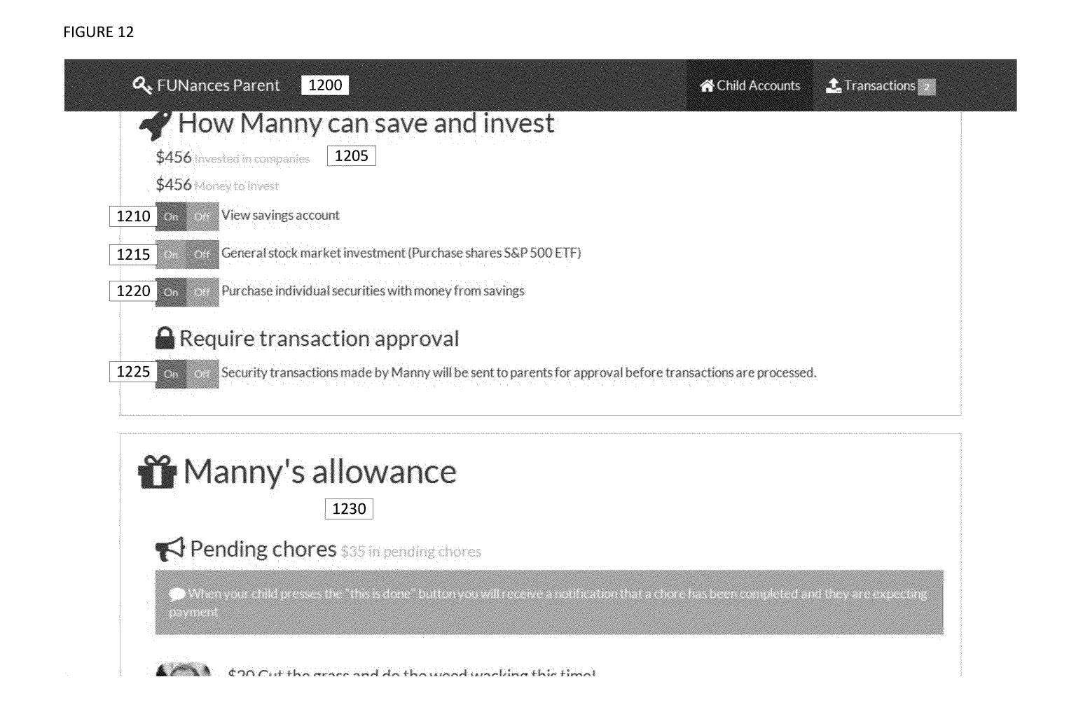

FIG. 12 shows a screenshot diagram illustrating embodiments of the IAD. In FIG. 12, an exemplary IAD webpage 1200 is shown, which is a scrolled down view of the IAD webpage 1100. The “How Manny can save and invest” section 1205 facilitates specifying investments parameters for the custodial account. These and other parameters may be specified when opening the custodial account and/or changed at any time if the parent wishes to modify parameters settings. For example, the parent may use the “View savings account” switch 1210 to specify whether the child is allowed to view information about the child's investments (e.g., yes). In another example, the parent may use the “General stock market investment” switch 1215 to specify whether the child is allowed to invest into shares of S&P 500 ETF (e.g., no), and the “Purchase individual securities” switch 1220 to specify whether the child is allowed to invest into individual securities (e.g., yes). In yet another example, the parent may use the “Require transaction approval” switch 1225 to specify whether parental approval should be obtained for investments the child wishes to make using the custodial account (e.g., yes).

The “Manny's allowance” section 1230 facilitates conditional funds deposits. For example, the parent may view pending chores that the parent set up for the child and/or associated payments.

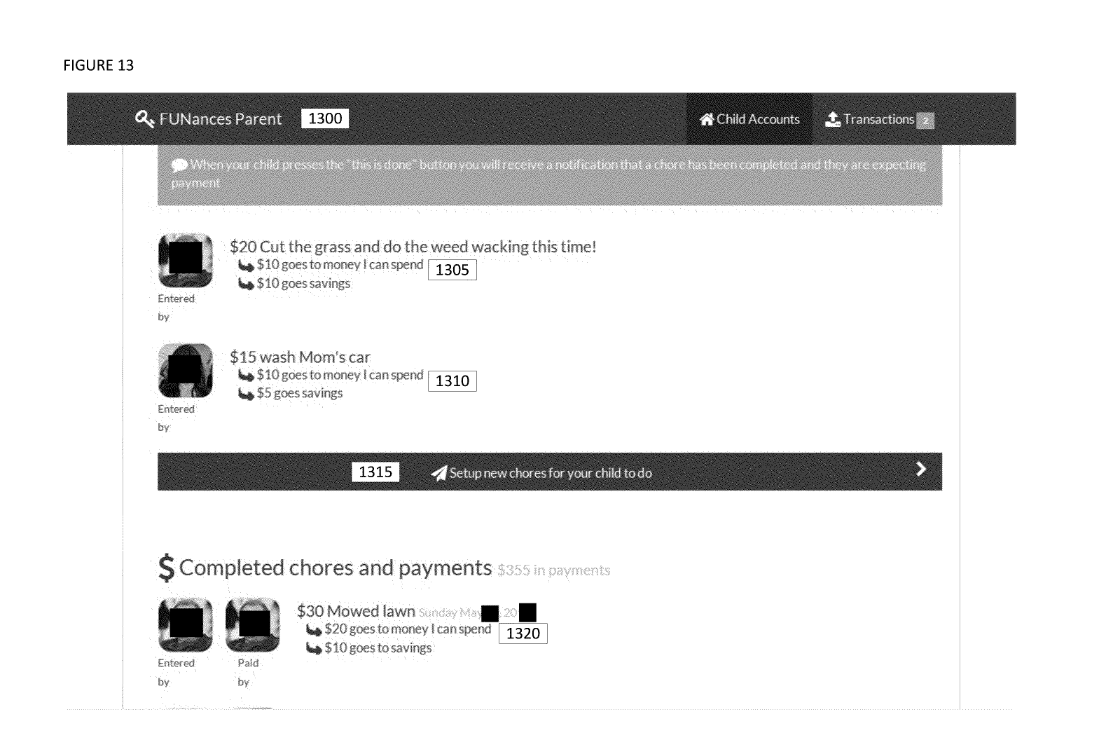

FIG. 13 shows a screenshot diagram illustrating embodiments of the IAD. In FIG. 13, an exemplary IAD webpage 1300 is shown, which is a scrolled down view of the IAD webpage 1200. Continuing with the Manny's allowance” section 1230, the parent may see a pending chore 1305, cut the grass, the completion of which rewards the child with $20, and a pending chore 1310, wash Mom's car, the completion of which rewards the child with $15. The parent may also see how the money is to be allocated between money for purchases and money for investments. The parent may click on the “Setup new chores for your child to do” button 1315 to initiate a parent funds deposit request. The parent may view completed chores that the parent set up for the child and/or associated payments. For example, the parent may see a completed chore 1320, mowed lawn, the completion of which rewarded the child with $30. The parent may also see how the money was allocated between money for purchases and money for investments.

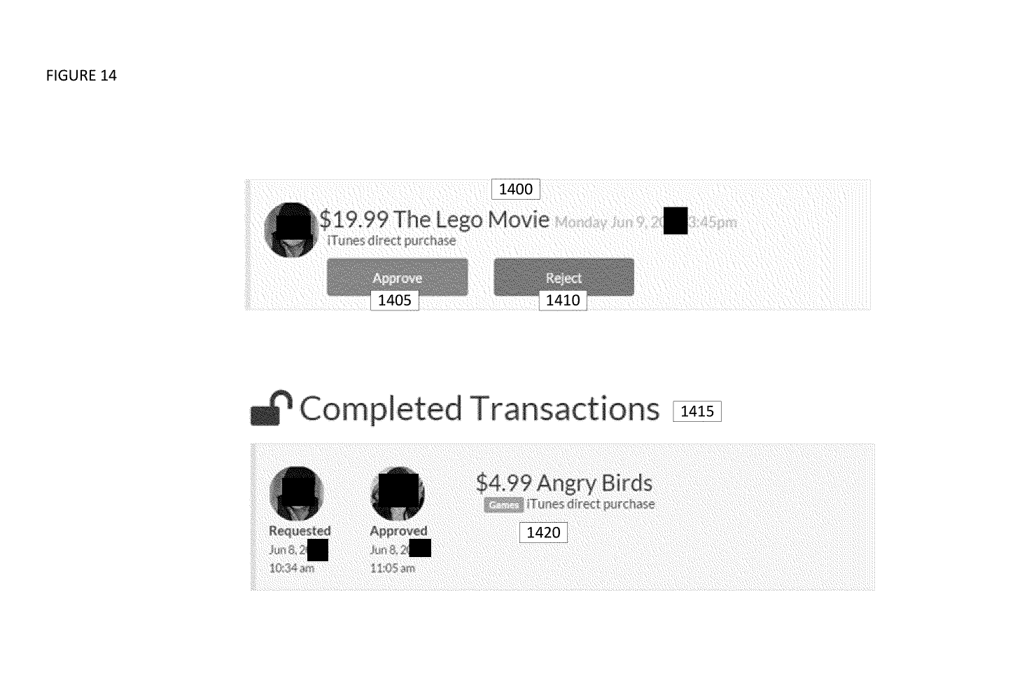

FIG. 14 shows a screenshot diagram illustrating embodiments of the IAD. In FIG. 14, an exemplary purchase approval notification 1400 is shown. For example, the purchase approval notification may inform the parent that the child wishes to purchase “The Lego Movie” for $19.99 from iTunes using funds in the custodial account allocated for purchases. In one implementation, the notification may be sent to any client device associated with the custodial account. For example, the notification may be sent to the parent's smartphone and tablet via the IAD mobile app installed on these client devices. The parent may click on the “Approve” button 1405 to approve the purchase or on the “Reject” button 1410 to reject the purchase. The parent may also view completed transactions 1415. For example, the parent may see a completed transaction 1420, purchase of “Angry Birds” game from iTunes for $4.99 using funds in the custodial account allocated for purchases, and/or who approved the transaction (e.g., the parent, the parent's spouse).

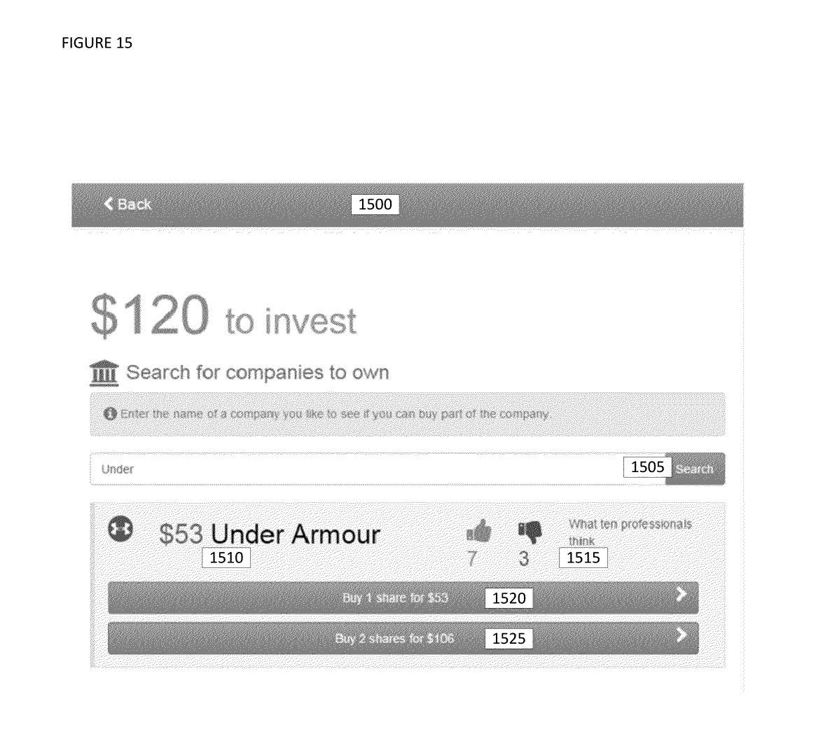

FIG. 15 shows a screenshot diagram illustrating embodiments of the IAD. In FIG. 15, an exemplary IAD webpage 1500 is shown, which may be generated during processing of an investment request (e.g., in response to the child clicking on the “Invest in a company” button 820). The search widget 1505 facilitates searching for securities that are allowed investment securities. For example, the child may search for “Under.” A search result 1510 may show a company (e.g., Under Armor) that matches the search term “Under” and/or a price per share for the company (e.g., $53 per share). The IAD webpage may show the child how professionals rate 1515 the security (e.g., 7 professionals give the security thumbs up and 3 professionals give the security thumbs down). Since the child has $120 to invest, the child may purchase 1 or 2 shares. Accordingly, the IAD webpage may include a “Buy 1 share for $53” button 1520 and a “Buy 2 shares for $106” button 1525 that facilitate selection by the child of a desired number of shares of the security for investment.

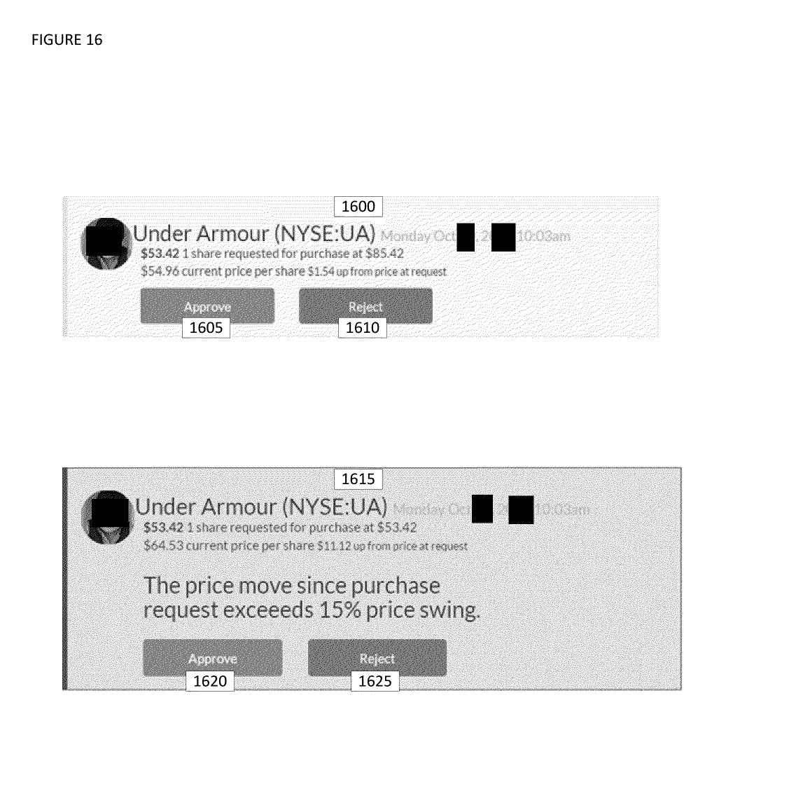

FIG. 16 shows a screenshot diagram illustrating embodiments of the IAD. In FIG. 16, an exemplary investment approval notification 1600 is shown. For example, the investment approval notification may inform the parent that the child wishes to purchase 1 share of Under Armor (NYSE:UA) security using funds in the custodial account allocated for investments. The investment approval notification may also inform the parent that the child requested investment approval when the price per share was $53.42 and that the current price per share is $54.96. In one implementation, the notification may be sent to any client device associated with the custodial account. For example, the notification may be sent to the parent's smartphone and tablet via the IAD mobile app installed on these client devices. The parent may click on the “Approve” button 1605 to approve the investment or on the “Reject” button 1610 to reject the investment.

An exemplary re-approval notification 1615 may be sent if price swing protection has been triggered for the security. For example, the price swing protection may be set at 15% of the price. If the child requested investment approval when the price per share was $53.42 and the current price per share is $64.53, the parent may be prompted to re-approve the investment. The parent may click on the “Approve” button 1620 to re-approve the investment or on the “Reject” button 1625 to reject the investment.

### IAD Controller

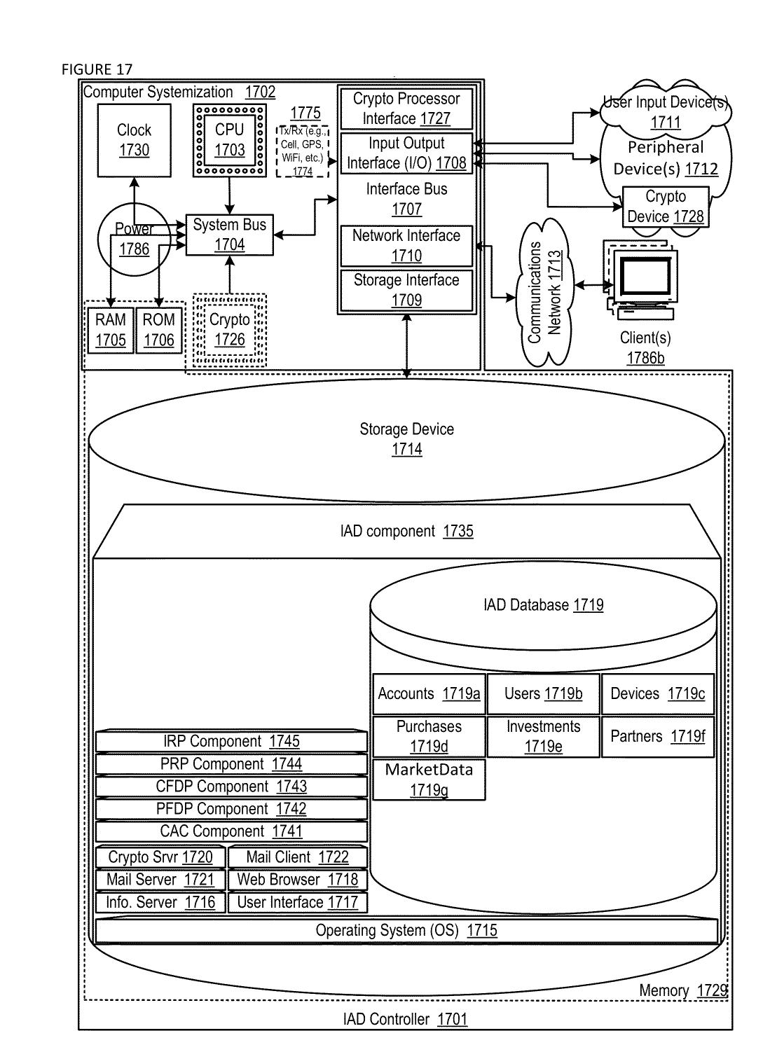

FIG. 17 shows a block diagram illustrating embodiments of a IAD controller. In this embodiment, the IAD controller 1701 may serve to aggregate, process, store, search, serve, identify, instruct, generate, match, and/or facilitate interactions with a computer through asset information technology technologies, and/or other related data.

Typically, users, which may be people and/or other systems, may engage information technology systems (e.g., computers) to facilitate information processing. In turn, computers employ processors to process information; such processors 1703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the IAD controller 1701 may be connected to and/or communicate with entities such as, but not limited to: one or more users from user input devices 1711; peripheral devices 1712; an optional cryptographic processor device 1728; and/or a communications network 1713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The IAD controller 1701 may be based on computer systems that may comprise, but are not limited to, components such as: a computer systemization 1702 connected to memory 1729.

### Computer Systemization

A computer systemization 1702 may comprise a clock 1730, central processing unit (“CPU(s)” and/or “processor(s)” (these terms are used interchangeable throughout the disclosure unless noted to the contrary)) 1703, a memory 1729 (e.g., a read only memory (ROM) 1706, a random access memory (RAM) 1705, etc.), and/or an interface bus 1707, and most frequently, although not necessarily, are all interconnected and/or communicating through a system bus 1704 on one or more (mother)board(s) 1702 having conductive and/or otherwise transportive circuit pathways through which instructions (e.g., binary encoded signals) may travel to effectuate communications, operations, storage, etc. The computer systemization may be connected to a power source 1786; e.g., optionally the power source may be internal. Optionally, a cryptographic processor 1726 may be connected to the system bus. In another embodiment, the cryptographic processor and/or transceivers (e.g., ICs) 1774 may be connected as either internal and/or external peripheral devices 1712 via the interface bus I/O 1708 (not pictured) and/or directly via the interface bus 1707. In turn, the transceivers may be connected to antenna(s) 1775, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4750IUB8 receiver chip (e.g., GPS); a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, global positioning system (GPS) (thereby allowing IAD controller to determine its location); a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large mainframe computers, down to mini computers, servers, desktop computers, laptops, netbooks, tablets (e.g., iPads, Android and Windows tablets, etc.), mobile smartphones (e.g., iPhones, Android and Windows phones, etc.), wearable devise (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1729 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the IAD controller and beyond through various interfaces. Should processing requirements dictate a greater amount speed and/or capacity, distributed processors (e.g., Distributed IAD), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the IAD may be achieved by implementing a microcontroller such as CAST's R8051XC2 microcontroller; Intel's MCS 51 (i.e., 8051 microcontroller); and/or the like. Also, to implement certain features of the IAD, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the IAD component collection (distributed or otherwise) and/or features may be implemented via the microprocessor and/or via embedded components; e.g., via ASIC, coprocessor, DSP, FPGA, and/or the like. Alternately, some implementations of the IAD may be implemented with embedded components that are configured and used to achieve a variety of features or signal processing.

Depending on the particular implementation, the embedded components may include software solutions, hardware solutions, and/or some combination of both hardware/software solutions. For example, IAD features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the IAD features. A hierarchy of programmable interconnects allow logic blocks to be interconnected as needed by the IAD system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the IAD may be developed on regular FPGAs and then migrated into a fixed version that more resembles ASIC implementations. Alternate or coordinating implementations may migrate IAD controller features to a final ASIC instead of or in addition to FPGAs. Depending on the implementation all of the aforementioned embedded components and microprocessors may be considered the “CPU” and/or “processor” for the IAD.

### Power Source

The power source 1786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1786 is connected to at least one of the interconnected subsequent components of the IAD thereby providing an electric current to all subsequent components. In one example, the power source 1786 is connected to the system bus component 1704. In an alternative embodiment, an outside power source 1786 is provided through a connection across the I/O 1708 interface. For example, a USB and/or IEEE 1394 connection carries both data and power across the connection and is therefore a suitable source of power.

### Interface Adapters

Interface bus(ses) 1707 may accept, connect, and/or communicate to a number of interface adapters, conventionally although not necessarily in the form of adapter cards, such as but not limited to: input output interfaces (I/O) 1708, storage interfaces 1709, network interfaces 1710, and/or the like. Optionally, cryptographic processor interfaces 1727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1709 may accept, communicate, and/or connect to a number of storage devices such as, but not limited to: storage devices 1714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1710 may accept, communicate, and/or connect to a communications network 1713. Through a communications network 1713, the IAD controller is accessible through remote clients 1733b (e.g., computers with web browsers) by users 1733a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed IAD), architectures may similarly be employed to pool, load balance, and/or otherwise decrease/increase the communicative bandwidth required by the IAD controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1710 may be used to engage with various communications network types 1713. For example, multiple network interfaces may be employed to allow for the communication over broadcast, multicast, and/or unicast networks.

Input Output interfaces (I/O) 1708 may accept, communicate, and/or connect to user input devices 1711, peripheral devices 1712, cryptographic processor devices 1728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1712 may be connected and/or communicate to I/O and/or other facilities of the like such as network interfaces, storage interfaces, directly to the interface bus, system bus, the CPU, and/or the like. Peripheral devices may be external, internal and/or part of the IAD controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the IAD controller may be embodied as an embedded, dedicated, and/or monitor-less (i.e., headless) device, wherein access would be provided over a network interface connection.

Cryptographic units such as, but not limited to, microcontrollers, processors 1726, interfaces 1727, and/or devices 1728 may be attached, and/or communicate with the IAD controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1729. However, memory is a fungible technology and resource, thus, any number of memory embodiments may be employed in lieu of or in concert with one another. It is to be understood that the IAD controller and/or a computer systemization may employ various forms of memory 1729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1729 will include ROM 1706, RAM 1705, and a storage device 1714. A storage device 1714 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RANI/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 1729 may contain a collection of program and/or database components and/or data such as, but not limited to: operating system component(s) 1715 (operating system); information server component(s) 1716 (information server); user interface component(s) 1717 (user interface); Web browser component(s) 1718 (Web browser); database(s) 1719; mail server component(s) 1721; mail client component(s) 1722; cryptographic server component(s) 1720 (cryptographic server); the IAD component(s) 1735; and/or the like (i.e., collectively a component collection). These components may be stored and accessed from the storage devices and/or from storage devices accessible through an interface bus. Although non-conventional program components such as those in the component collection, typically, are stored in a local storage device 1714, they may also be loaded and/or stored in memory such as: peripheral devices, RAM, remote storage facilities through a communications network, ROM, various forms of memory, and/or the like.

### Operating System

The operating system component 1715 is an executable program component facilitating the operation of the IAD controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the IAD controller to communicate with other entities through a communications network 1713. Various communication protocols may be used by the IAD controller as a subcarrier transport mechanism for interaction, such as, but not limited to: multicast, TCP/IP, UDP, unicast, and/or the like.

### Information Server

An information server component 1716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the IAD controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the IAD database 1719, operating systems, other program components, user interfaces, Web browsers, and/or the like.

Access to the IAD database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the IAD. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the IAD as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome; Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1718 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the IAD enabled nodes. The combined application may be nugatory on systems employing standard Web browsers.

### Mail Server

A mail server component 1721 is a stored program component that is executed by a CPU 1703. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the IAD.

Access to the IAD mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1722 is a stored program component that is executed by a CPU 1703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1720 is a stored program component that is executed by a CPU 1703, cryptographic processor 1726, cryptographic processor interface 1727, cryptographic processor device 1728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the IAD may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the IAD component to engage in secure transactions if so desired. The cryptographic component facilitates the secure accessing of resources on the IAD and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The IAD Database

The IAD database component 1719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the IAD database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the IAD database is implemented as a data-structure, the use of the IAD database 1719 may be integrated into another component such as the IAD component 1735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1719 includes several tables 1719a-g:

An accounts table 1719a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 1719b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a IAD);

An devices table 1719c includes fields such as, but not limited to: deviceID, accountID, assetIDs, paymentIDs, deviceType, deviceName, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, device Preferences, deviceRestrictions, and/or the like;

A purchases table 1719d includes fields such as, but not limited to: purchaseID, accountID, assetIDs, deviceIDs, paymentIDs, purchaseIDs, userID, purchaseType, purchaseDate, purchaseAmount, purchaseQuantity, purchaseDetails, transactionNo, purchaseAccessPrivileges, purchasePreferences, purchaseRestrictions, purchaseApprovalDetails, purchaseReferralFee, purchasePartnerID, and/or the like;

An investments table 1719e includes fields such as, but not limited to: investmentID, accountID, assetIDs, deviceIDs, paymentIDs, investmentIDs, userID, investmentType, investmentDate, investmentSecurity, investmentPricePerShare, investmentNumberOfShares, investmentDetails, transactionNo, investmentAccessPrivileges, investmentPreferences, investmentRestrictions, investmentApprovalDetails, investmentReApprovalDetails, and/or the like;

A partners table 1719f includes fields such as, but not limited to: partnerID, partnerTaxID, partnerName, partnerContactUserID, partnerEmail, partnerAddress, partnerState, partnerZIPcode, partnerCountry, partnerAuthKey, partnerIPaddress, partnerURLaccessCode, partnerPortNo, partnerAccessPrivileges, partnerPreferences, partnerRestrictions, partnerReferralFeeSchedule, and/or the like;

A market_data table 1719g includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the IAD database may interact with other database systems. For example, employing a distributed database system, queries and data access by search IAD component may treat the combination of the IAD database, an integrated data security layer database as a single database entity.

In one embodiment, user programs may contain various user interface primitives, which may serve to update the IAD. Also, various accounts may require custom database tables depending upon the environments and the types of clients the IAD may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1719a-g. The IAD may be configured to keep track of various settings, inputs, and parameters via database controllers.

The IAD database may communicate to and/or with other components in a component collection, including itself, and/or facilities of the like. Most frequently, the IAD database communicates with the IAD component, other program components, and/or the like. The database may contain, retain, and provide information regarding other nodes and data.

### The IADs

The IAD component 1735 is a stored program component that is executed by a CPU. In one embodiment, the IAD component incorporates any and/or all combinations of the aspects of the IAD that was discussed in the previous figures. As such, the IAD affects accessing, obtaining and the provision of information, services, transactions, and/or the like across various communications networks. The features and embodiments of the IAD discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the IAD's features and facilities, and in many cases reduce the costs, energy consumption/requirements, and extend the life of IAD's underlying infrastructure; this has the added benefit of making the IAD more reliable. Similarly, many of the features and mechanisms are designed to be easier for users to use and access, thereby broadening the audience that may enjoy/employ and exploit the feature sets of the IAD; such ease of use also helps to increase the reliability of the IAD. In addition, the feature sets include heightened security as noted via the Cryptographic components 1720, 1726, 1728 and throughout, making access to the features and data more reliable and secure.

The IAD transforms purchase request and investment request inputs, via IAD components (e.g., CAC, PFDP, CFDP, PRP, IRP), into order request, purchase response, and investment response outputs.

The IAD component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the IAD server employs a cryptographic server to encrypt and decrypt communications. The IAD component may communicate to and/or with other components in a component collection, including itself, and/or facilities of the like. Most frequently, the IAD component communicates with the IAD database, operating systems, other program components, and/or the like. The IAD may contain, communicate, generate, obtain, and/or provide program component, system, user, and/or data communications, requests, and/or responses.

### Distributed IADs

The structure and/or operation of any of the IAD node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the IAD controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation @SON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the IAD controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:
http://www.xay.com/perl/site/lib/SOAP/Parser.html
http://publib.boulder.ibm.com/infocenter/tivihelp/v2r1/index.jsp?topic=/com.ibm.IBMDI.doc/referenceguide295.htm

and other parser implementations:
http://publib.boulder.ibm.com/infocenter/tivihelp/v2r1/index.jsp?topic=/com.ibm.IBMDI.doc/referenceguide259.htm

all of which are hereby expressly incorporated by reference.

In order to address various issues and advance the art, the entirety of this application for Insulated Account Datastructure Apparatuses, Methods and Systems (including the Cover Page, Tide, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a IAD individual and/or enterprise user, database configuration and/or relational model, data type, data transmission and/or network framework, syntax structure, and/or the like, various embodiments of the IAD, may be implemented that enable a great deal of flexibility and customization. For example, aspects of the IAD may be adapted to make investing approachable for new adult investors. While various embodiments and discussions of the IAD have included asset information technology, however, it is to be understood that the embodiments described herein may be readily configured and/or customized for a wide variety of other applications and/or implementations.

What is claimed is:

1. An insulated account investment request processing apparatus, comprising:
a memory;
a component collection in the memory, including:
an investment request processing component;
a processor disposed in communication with the memory, and configured to issue a plurality of processing instructions from the component collection stored in the memory,
wherein the processor issues instructions from the investment request processing component, stored in the memory, to:
obtain, via network, an investment request associated with trading a security from a beneficiary associated with an insulated account;
determine, via processor, investment approval obtaining settings associated with the insulated account;
send, via network, an investment approval notification for a custodian associated with the insulated account in accordance with the investment approval obtaining settings;
obtain, via network, an investment approval response indicating approval for trading the security from the custodian; and
generate, via processor, a securities order for the security from the custodian from the insulated account.

2. The apparatus of claim 1, further, comprising:
the processor issues instructions from the investment request processing component, stored in the memory, to:
determine allowed investments settings associated with the insulated account; and
facilitate selection of the security from a set of allowed investment securities specified by the allowed investments settings.

3. The apparatus of claim 2, wherein instructions to facilitate selection of the security further comprise instructions to facilitate selection of the security from a list of securities.

4. The apparatus of claim 2, wherein instructions to facilitate selection of the security further comprise instructions to facilitate searching for the security.

5. The apparatus of claim 1, further, comprising:
the processor issues instructions from the investment request processing component, stored in the memory, to:
calculate the maximum number of shares of the securities that may be bought using funds in the insulated account; and
facilitate selection of a desired number of shares of the securities, wherein the desired number of shares does not exceed the calculated maximum number of shares.

6. The apparatus of claim 1, wherein the investment approval notification is any of: an email, a mobile app message, a web app message, an SMS message.

7. The apparatus of claim 1, wherein the investment approval notification is simultaneously sent to a plurality of client devices associated with the custodian.

8. The apparatus of claim 1, wherein the custodian is one of a plurality of custodians associated with the insulated account, and wherein the investment approval obtaining settings specify which of the plurality of custodians are to be sent investment approval notifications.

9. The apparatus of claim 1, further, comprising:
the processor issues instructions from the investment request processing component, stored in the memory, to:
determine price swing protection settings associated with the insulated account;
determine that price swing protection for the security has been triggered in accordance with the price swing protection settings; and
send a first price swing protection notification for the custodian.

10. The apparatus of claim 9, further, comprising:
the processor issues instructions from the investment request processing component, stored in the memory, to:
send a second price swing protection notification for the beneficiary.

11. The apparatus of claim 1, further, comprising:
the processor issues instructions from the investment request processing component, stored in the memory, to:
verify availability of funds for the securities order in the insulated account.

12. The apparatus of claim 1, wherein instructions to generate the securities order further comprise instructions to place the securities order with a securities exchange.

13. The apparatus of claim 1, further, comprising:
the processor issues instructions from the investment request processing component, stored in the memory, to:
update funds balance associated with the insulated account to reflect the amount spent on the securities order.

14. The apparatus of claim 1, further, comprising:
a parent funds deposit processing component in the component collection, and
the processor issues instructions from the parent funds deposit processing component, stored in the memory, to:
obtain, via network, a parent funds deposit request;
determine, via processor, funds allocation for deposit funds associated with the parent funds deposit request;
allocate, via processor, in accordance with the funds allocation, a first portion of the deposit funds to a checking account associated with the insulated account, wherein funds in the checking account are allocated for making retail purchases;
allocate, via processor, in accordance with the funds allocation, a second portion of the deposit funds to a savings account associated with the insulated account, wherein funds in the savings account are allocated for making investments; and
wherein instructions to generate the securities order further comprise instructions to place the securities order using funds in the savings account associated with the insulated account.

15. An insulated account investment request processing non-transient medium storing processor-executable components, the components, comprising:
a component collection stored in the medium, including:
an investment request processing component;
wherein the investment request processing component, stored in the medium, includes processor-issuable instructions, to:
obtain, via network, an investment request associated with trading a security from a beneficiary associated with an insulated account;
determine, via processor, investment approval obtaining settings associated with the insulated account;
send, via network, an investment approval notification for a custodian associated with the insulated account in accordance with the investment approval obtaining settings;
obtain, via network, an investment approval response indicating approval for trading the security from the custodian; and
generate, via processor, a securities order for the security from the custodian from the insulated account.

16. The medium of claim 15, further, comprising:
wherein the investment request processing component, stored in the medium, includes processor-issuable instructions, to:
determine allowed investments settings associated with the insulated account; and
facilitate selection of the security from a set of allowed investment securities specified by the allowed investments settings.

17. The medium of claim 16, wherein instructions to facilitate selection of the security further comprise instructions to facilitate selection of the security from a list of securities.

18. The medium of claim 16, wherein instructions to facilitate selection of the security further comprise instructions to facilitate searching for the security.

19. The medium of claim 15, further, comprising:
wherein the investment request processing component, stored in the medium, includes processor-issuable instructions, to:
calculate the maximum number of shares of the securities that may be bought using funds in the insulated account; and
facilitate selection of a desired number of shares of the securities, wherein the desired number of shares does not exceed the calculated maximum number of shares.

20. The medium of claim 15, wherein the investment approval notification is any of: an email, a mobile app message, a web app message, an SMS message.

21. The medium of claim 15, wherein the investment approval notification is simultaneously sent to a plurality of client devices associated with the custodian.

22. The medium of claim 15, wherein the custodian is one of a plurality of custodians associated with the insulated account, and wherein the investment approval obtaining settings specify which of the plurality of custodians are to be sent investment approval notifications.

23. The medium of claim 15, further, comprising:
wherein the investment request processing component, stored in the medium, includes processor-issuable instructions, to:
determine price swing protection settings associated with the insulated account;
determine that price swing protection for the security has been triggered in accordance with the price swing protection settings; and
send a first price swing protection notification for the custodian.

24. The medium of claim 23, further, comprising:
wherein the investment request processing component, stored in the medium, includes processor-issuable instructions, to:
send a second price swing protection notification for the beneficiary.

25. The medium of claim 15, further, comprising:
wherein the investment request processing component, stored in the medium, includes processor-issuable instructions, to:
verify availability of funds for the securities order in the insulated account.

26. The medium of claim 15, wherein instructions to generate the securities order further comprise instructions to place the securities order with a securities exchange.

27. The medium of claim 15, further, comprising:
wherein the investment request processing component, stored in the medium, includes processor-issuable instructions, to:
update funds balance associated with the insulated account to reflect the amount spent on the securities order.

28. The medium of claim 15, further, comprising:
a parent funds deposit processing component in the component collection, and
wherein the investment request processing component, stored in the medium, includes processor-issuable instructions, to:
obtain, via network, a parent funds deposit request;
determine, via processor, funds allocation for deposit funds associated with the parent funds deposit request;
allocate, via processor, in accordance with the funds allocation, a first portion of the deposit funds to a checking account associated with the insulated account, wherein funds in the checking account are allocated for making retail purchases;
allocate, via processor, in accordance with the funds allocation, a second portion of the deposit funds to a savings account associated with the insulated account, wherein funds in the savings account are allocated for making investments; and
wherein instructions to generate the securities order further comprise instructions to place the securities order using funds in the savings account associated with the insulated account.

29. An insulated account investment request processing system, comprising:
an investment request processing component storing processor-executable instruction means, to:
obtain, via network, an investment request associated with trading a security from a beneficiary associated with an insulated account;
determine, via processor, investment approval obtaining settings associated with the insulated account;
send, via network, an investment approval notification for a custodian associated with the insulated account in accordance with the investment approval obtaining settings;
obtain, via network, an investment approval response indicating approval for trading the security from the custodian; and
generate, via processor, a securities order for the security from the custodian from the insulated account.

30. The system of claim 29, further, comprising means, to:
determine allowed investments settings associated with the insulated account; and
facilitate selection of the security from a set of allowed investment securities specified by the allowed investments settings.

31. The system of claim 30, wherein instructions to facilitate selection of the security further comprise instructions to facilitate selection of the security from a list of securities.

32. The system of claim 30, wherein instructions to facilitate selection of the security further comprise instructions to facilitate searching for the security.

33. The system of claim 29, further, comprising, means, to:
calculate the maximum number of shares of the securities that may be bought using funds in the insulated account; and
facilitate selection of a desired number of shares of the securities, wherein the desired number of shares does not exceed the calculated maximum number of shares.

34. The system of claim 29, wherein the investment approval notification includes any of: an email, a mobile app message, a web app message, an SMS message.

35. The system of claim 29, wherein the investment approval notification is simultaneously sent to a plurality of client devices associated with the custodian.

36. The system of claim 29, wherein the custodian is one of a plurality of custodians associated with the insulated account, and wherein the investment approval obtaining settings specify which of the plurality of custodians are to be sent investment approval notifications.

37. The system of claim 29, further, comprising, means, to:
determine price swing protection settings associated with the insulated account;
determine that price swing protection for the security has been triggered in accordance with the price swing protection settings; and
send a first price swing protection notification for the custodian.

38. The system of claim 37, further, comprising, means, to:
send a second price swing protection notification for the beneficiary.

39. The system of claim 29, further, comprising, means, to:
verify availability of funds for the securities order in the insulated account.

40. The system of claim 29, wherein instructions to generate the securities order further comprise instructions to place the securities order with a securities exchange.

41. The system of claim 29, further, comprising, means, to:
update funds balance associated with the insulated account to reflect the amount spent on the securities order.

42. The system of claim 29, further, comprising:
a parent funds deposit processing component in the component collection, and
investment request processing component, means, to:
obtain, via network, a parent funds deposit request;
determine, via processor, funds allocation for deposit funds associated with the parent funds deposit request;
allocate, via processor, in accordance with the funds allocation, a first portion of the deposit funds to a checking account associated with the insulated account, wherein funds in the checking account are allocated for making retail purchases;
allocate, via processor, in accordance with the funds allocation, a second portion of the deposit funds to a savings account associated with the insulated account, wherein funds in the savings account are allocated for making investments; and
wherein instructions to generate the securities order further comprise instructions to place the securities order using funds in the savings account associated with the insulated account.

43. An insulated account investment request processing method, comprising:
executing processor-implemented investment request processing component instructions to:
obtain, via network, an investment request associated with trading a security from a beneficiary associated with an insulated account;
determine, via processor, investment approval obtaining settings associated with the insulated account;
send, via network, an investment approval notification for a custodian associated with the insulated account in accordance with the investment approval obtaining settings;
obtain, via network, an investment approval response indicating approval for trading the security from the custodian; and
generate, via processor, a securities order for the security from the custodian from the insulated account.

44. The method of claim 43, further, comprising instructions, to:
determine allowed investments settings associated with the insulated account; and
facilitate selection of the security from a set of allowed investment securities specified by the allowed investments settings.

45. The method of claim 44, wherein instructions to facilitate selection of the security further comprise instructions to facilitate selection of the security from a list of securities.

46. The method of claim 44, wherein instructions to facilitate selection of the security further comprise instructions to facilitate searching for the security.

47. The method of claim 43, further, comprising, instructions, to:
calculate the maximum number of shares of the securities that may be bought using funds in the insulated account; and
facilitate selection of a desired number of shares of the securities, wherein the desired number of shares does not exceed the calculated maximum number of shares.

48. The method of claim 43, wherein the investment approval notification includes any of: an email, a mobile app message, a web app message, an SMS message.

49. The method of claim 43, wherein the investment approval notification is simultaneously sent to a plurality of client devices associated with the custodian.

50. The method of claim 43, wherein the custodian is one of a plurality of custodians associated with the insulated account, and wherein the investment approval obtaining settings specify which of the plurality of custodians are to be sent investment approval notifications.

51. The method of claim 43, further, comprising, instructions, to:
determine price swing protection settings associated with the insulated account;
determine that price swing protection for the security has been triggered in accordance with the price swing protection settings; and
send a first price swing protection notification for the custodian.

52. The method of claim 51, further, comprising, instructions, to:
send a second price swing protection notification for the beneficiary.

53. The method of claim 43, further, comprising, instructions, to:
verify availability of funds for the securities order in the insulated account.

54. The method of claim 43, wherein instructions to generate the securities order further comprise instructions to place the securities order with a securities exchange.

55. The method of claim 43, further, comprising, instructions, to:
update funds balance associated with the insulated account to reflect the amount spent on the securities order.

56. The method of claim 43, further, comprising:
executing processor-implemented parent funds deposit processing component from the component collection, and
executing processor-implemented investment request processing component, instructions, to:
obtain, via network, a parent funds deposit request;
determine, via processor, funds allocation for deposit funds associated with the parent funds deposit request;
allocate, via processor, in accordance with the funds allocation, a first portion of the deposit funds to a checking account associated with the insulated account, wherein funds in the checking account are allocated for making retail purchases;
allocate, via processor, in accordance with the funds allocation, a second portion of the deposit funds to a savings account associated with the insulated account, wherein funds in the savings account are allocated for making investments; and
wherein instructions to generate the securities order further comprise instructions to place the securities order using funds in the savings account associated with the insulated account.
